(19) United States
(12) Patent Application Publication
(10) Pub. No.: US 2025/0271742 A1
(43) Pub. Date: Aug. 28, 2025

(54) LIGHT SOURCE DEVICE AND PROJECTOR

(71) Applicant: SEIKO EPSON CORPORATION, Tokyo (JP)

(72) Inventor: Tomohiro YOKOO, MATSUMOTO-SHI (JP)

(21) Appl. No.: 19/062,550

(22) Filed: Feb. 25, 2025

(30) Foreign Application Priority Data
Feb. 26, 2024 (JP) 2024-026309

(51) Int. Cl. G03B 21/20

(52) U.S. Cl. CPC G03B 21/204; G03B 21/2013; G03B 21/2066

(57) ABSTRACT

A light source device includes a first light source emitting a first light, a first wavelength conversion element converting the first light into a second light, a first optical layer transmitting the first light and reflecting the second light, a first light guide portion guiding the second light, a second light source emitting a third light, a second wavelength conversion element converting the third light into a fourth light, a second optical layer transmitting the third light and reflecting the fourth light, and a second light guide portion guiding the fourth light. The first wavelength conversion element includes a first surface entered by the first light and a second surface and a third surface crossing the first surface. The second wavelength conversion element includes a fourth surface entered by the third light and a fifth surface and a sixth surface crossing the fourth surface. The second light travels through the first light guide portion, is emitted from a region of the first light guide portion at the third surface side, and enters a region of the second light guide portion at the fifth surface side. The fourth light and the second light travel through the second light guide portion and are emitted from a region of the second light guide portion at the sixth surface side.

The present application is based on, and claims priority from JP Application Serial Number 2024-026309, filed Feb. 26, 2024, the disclosure of which is hereby incorporated by reference herein in its entirety.

### BACKGROUND

### 1. Technical Field

The present disclosure relates to a light source device and a projector.

### 2. Related Art

As a light source device used in a projector, there has been proposed a light source device using fluorescence emitted from a phosphor when the phosphor is irradiated with excitation light emitted from a light emitting element. WO 2006/054203 discloses a light source device including a wavelength conversion member that has a flat plate shape and contains a phosphor, and a light emitting diode that emits excitation light. In this light source device, of a plurality of surfaces of the wavelength conversion member, the excitation light is entered from an incident surface having a larger area and fluorescence is emitted from an emission surface having a smaller area.

WO 2006/054203 is an example of the related art.

In the light source device of WO 2006/054203, the fluorescence generated inside the wavelength conversion member is totally reflected at an interface between the surface of the wavelength conversion member and an air layer to thereby propagate inside the wavelength conversion member, and is then emitted from the emission surface. However, a component of the fluorescence that enters the interface between the wavelength conversion member and the air layer at an angle smaller than the critical angle is not totally reflected at the interface, and thus leaks to the outside from the interface before reaching the emission surface. Accordingly, there is a problem that the use efficiency of the fluorescence becomes lower.

### SUMMARY

A light source device according to an aspect of the present disclosure includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a first light guide portion disposed between the first optical layer and the first wavelength conversion element and guiding the second light converted by the first wavelength conversion element, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a second light guide portion disposed between the second optical layer and the second wavelength conversion element and guiding the fourth light converted by the second wavelength conversion element, and a first reflection member reflecting the first light and the second light. The first wavelength conversion element includes a first surface entered by the first light via the first optical layer and the first light guide portion, and a second surface and a third surface crossing the first surface and facing opposite sides to each other. The second wavelength conversion element includes a fourth surface entered by the third light via the second optical layer and the second light guide portion, and a fifth surface and a sixth surface crossing the fourth surface and facing opposite sides to each other. The first reflection member is disposed in a region at the second surface side of the first light guide portion. The second light converted by the first wavelength conversion element travels through the first light guide portion, is emitted from a region of the first light guide portion at the third surface side, and enters a region of the second light guide portion at the fifth surface side. The fourth light converted by the second wavelength conversion element and the second light emitted from the region at the third surface side travel through the second light guide portion and are emitted from a region of the second light guide portion at the sixth surface side.

A projector according to an aspect of the present disclosure includes the light source device according to the aspect of the present disclosure, a light modulation device modulating a light emitted from the light source device, and a projection optical device projecting the light modulated by the light modulation device.

### BRIEF DESCRIPTION OF THE DRAWINGS

FIG. 1 is a schematic configuration diagram of a projector according to a first embodiment.

FIG. 2 is a perspective view of a light source device according to the first embodiment.

FIG. 3 is a cross-sectional view of the light source device cut along line III-III in FIG. 2.

FIG. 4 is a cross-sectional view of the light source device cut along line IV-IV in FIG. 3.

FIG. 5 is a cross-sectional view of the light source device cut along line V-V in FIG. 3.

FIG. 6 is a cross-sectional view of a light source device according to a second embodiment.

FIG. 7 is a schematic diagram showing functions and effects of the light source device of the second embodiment.

FIG. 8 is a cross-sectional view of a light source device according to a third embodiment.

FIG. 9 is a cross-sectional view of a light source device according to a fourth embodiment.

FIG. 10 is a cross-sectional view of a light source device according to a fifth embodiment.

FIG. 11 is a cross-sectional view of a light source device according to a sixth embodiment.

FIG. 12 is a cross-sectional view of a light source device according to a seventh embodiment.

### DESCRIPTION OF EMBODIMENTS

### First Embodiment

As below, a first embodiment of the present disclosure will be described using the drawings.

A projector according to the embodiment is an example of a projector using liquid crystal panels as light modulation devices.

In the following drawings, some component elements may be shown at different dimensional scales for clarity of the respective component elements.

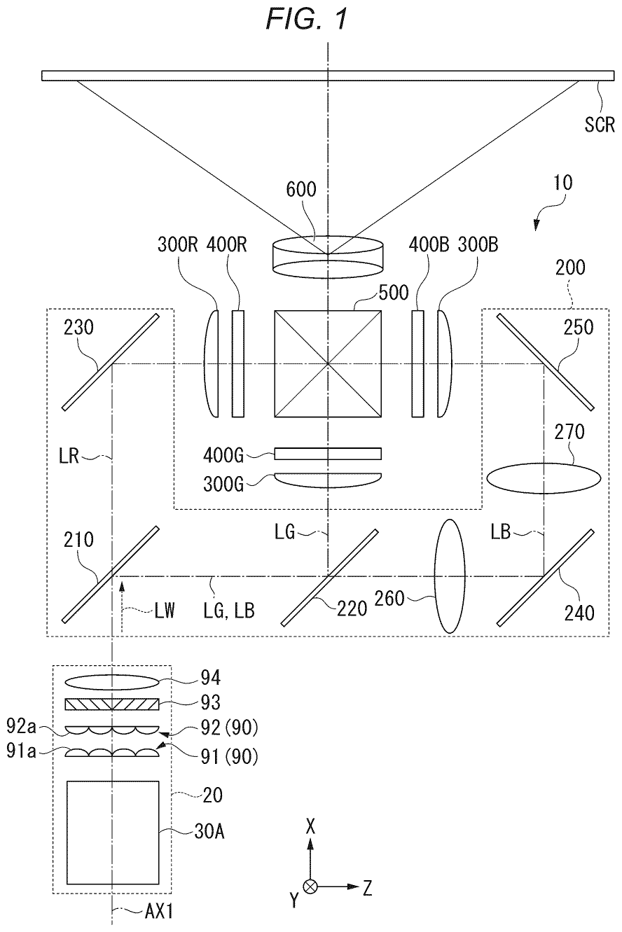

FIG. 1 is a schematic configuration diagram of a projector 10 of the embodiment.

As shown in FIG. 1, the projector 10 of the embodiment is a projection-type image display apparatus that displays a color image on a screen SCR as a projection surface. The projector 10 includes three light modulation devices respectively corresponding to color lights of a red light LR, a green light LG, and a blue light LB.

The projector 10 includes an illumination device 20, a color separation/light guide system 200, a red light modulation device 400R, a green light modulation device 400G, a blue light modulation device 400B, a light combining element 500, and a projection optical device 600.

The illumination device 20 includes a light source device 30A, an optical integration system 90, a polarization conversion element 93, and a superimposing system 94. The illumination device 20 emits a white light LW containing the red light LR, the green light LG, and the blue light LB. A specific configuration of the illumination device 20 will be described later.

The description with reference to the drawings will hereinafter be made using an X-Y-Z orthogonal coordinate system as necessary. An X-axis is an axis parallel to an optical axis AX1 of the illumination device 20 and along the front-back direction of the projector 10. A Y-axis is an axis orthogonal to the X-axis and along the vertical direction of the projector 10. A Z-axis is an axis orthogonal to the X-axis and the Y-axis, and along the left-right direction of the projector 10. The coordinate system is for description of the arrangement relationship among the component members of the projector 10, and does not limit an attitude and a direction of installation of the projector 10. The optical axis AX1 of the illumination device 20 is the center axis of the white light LW emitted from the illumination device 20.

In the following description, one of the two directions along the X-axis is referred to as “+X direction”, and the opposite direction is referred to as “−X direction”. One of the two directions along the Y-axis is referred to as “+Y direction”, and the opposite direction is referred to as “−Y direction”. One of the two directions along the Z-axis is referred to as “+Z direction”, and the opposite direction is referred to as “−Z direction”. The two directions along the X-axis may be collectively referred to as “X-axis direction” without distinction. The two directions along the Y-axis may be collectively referred to as “Y-axis direction” without distinction. The two directions along the Z-axis may be collectively referred to as “Z-axis direction” without distinction.

The color separation/light guide system 200 includes a first dichroic mirror 210, a second dichroic mirror 220, a first reflection mirror 230, a second reflection mirror 240, a third reflection mirror 250, a first relay lens 260, and a second relay lens 270. The color separation/light guide system 200 separates the white light LW emitted from the illumination device 20 into the red light LR, the green light LG, and the blue light LB, guides the red light LR to the red light modulation device 400R, guides the green light LG to the green light modulation device 400G, and guides the blue light LB to the blue light modulation device 400B.

A field lens 300R is disposed between the color separation/light guide system 200 and the red light modulation device 400R. A field lens 300G is disposed between the color separation/light guide system 200 and the green light modulation device 400G. A field lens 300B is disposed between the color separation/light guide system 200 and the blue light modulation device 400B. The field lens 300R parallelizes the principal ray of the red light LR to enter the light modulation device 400R. The field lens 300G parallelizes the principal ray of the green light LG to enter the light modulation device 400G. The field lens 300B parallelizes the principal ray of the blue light LB to enter the light modulation device 400B.

The first dichroic mirror 210 transmits the red light LR and reflects the green light LG and the blue light LB. The second dichroic mirror 220 reflects the green light LG and transmits the blue light LB. The first reflection mirror 230 reflects the red light LR. Each of the second reflection mirror 240 and the third reflection mirror 250 reflects the blue light LB.

Each of the red light modulation device 400R, the green light modulation device 400G, and the blue light modulation device 400B modulates the color light entered into each light modulation device according to image information to generate an image light. Each of the red light modulation device 400R, the green light modulation device 400G, and the blue light modulation device 400B includes a liquid crystal panel.

Though not illustrated, light incident-side polarizers are respectively disposed between the field lens 300R and the red light modulation device 400R, between the field lens 300G and the green light modulation device 400G, and between the field lens 300B and the blue light modulation device 400B. Further, light exiting-side polarizers are respectively disposed between the red light modulation device 400R and the light combining element 500, between the green light modulation device 400G and the light combining element 500, and between the blue light modulation device 400B and the light combining element 500. The light incident-side polarizer and the light exiting-side polarizer allow only a linearly-polarized light in a particular direction to pass through.

The light combining element 500 is incident by the image lights emitted from the light modulation device 400R, the light modulation device 400G, and the light modulation device 400B, combines the image lights corresponding to the red light LR, the green light LG, and the blue light LB, and outputs the combined image light toward the projection optical device 600. As the light combining element 500, for example, a cross dichroic prism is used.

The projection optical device 600 includes a plurality of projection lenses. The projection optical device 600 enlarges and projects the image light combined by the light combining element 500 toward the screen SCR. Thereby, an image is displayed on the screen SCR.

As below, configurations of the light source device 30A and the illumination device 20 will be described.

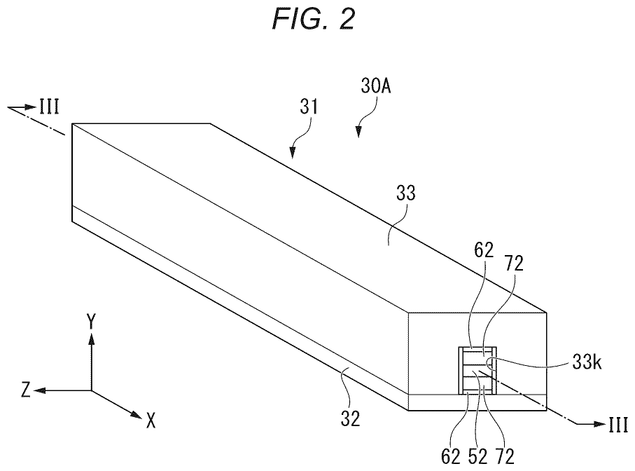

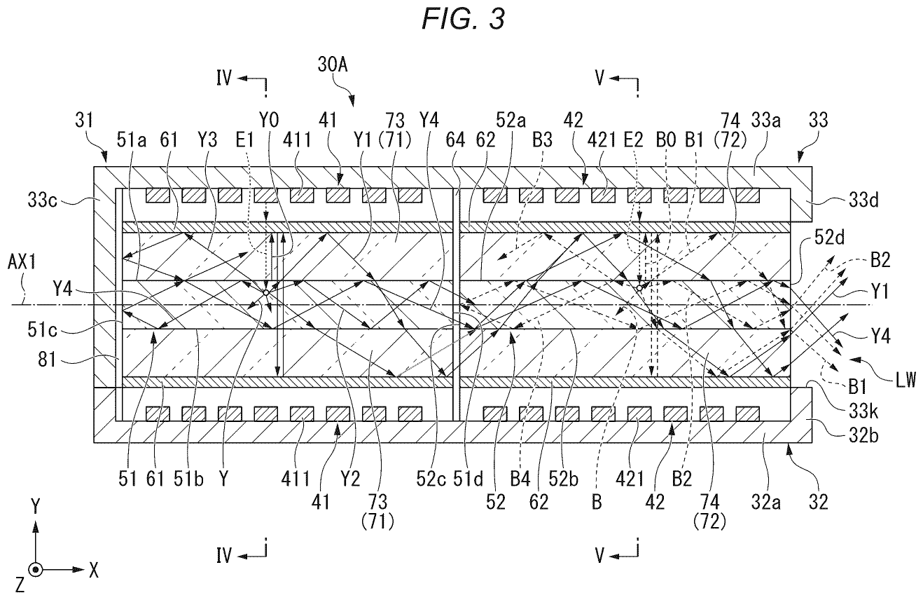

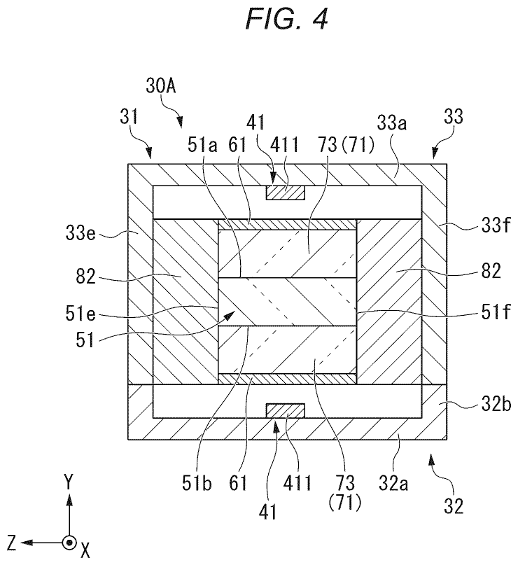

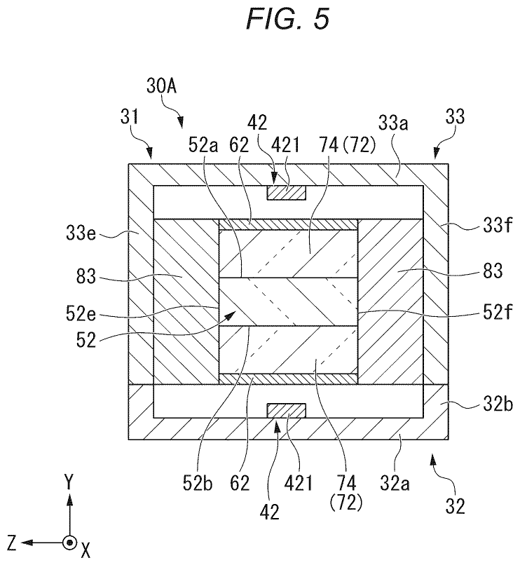

FIG. 2 is a perspective view of the light source device 30A of the embodiment. FIG. 3 is a cross-sectional view of the light source device 30A cut along line III-III in FIG. 2. FIG. 4 is a cross-sectional view of the light source device 30A cut along line IV-IV in FIG. 3. FIG. 5 is a cross-sectional view of the light source device 30A cut along the line V-V in FIG. 3.

As shown in FIGS. 2 to 5, the light source device 30A of the embodiment includes a housing 31, first light sources 41, a first wavelength conversion element 51, first optical layers 61, first light guide portions 71, second light sources 42, a second wavelength conversion element 52, second optical layers 62, second light guide portions 72, a first reflection member 81, second reflection members 82, third reflection members 83, and a fourth optical layer 64.

The housing 31 forms an exterior of the light source device 30A. The housing 31 houses the first light sources 41, the first optical layers 61, the first light guide portions 71, the first wavelength conversion element 51, the second light sources 42, the second optical layers 62, the second light guide portions 72, the second wavelength conversion element 52, the first reflection member 81, the second reflection members 82, the third reflection members 83, and the fourth optical layer 64. The housing 31 includes a bottom plate 32 and a lid 33. The bottom plate 32 has substantially a plate shape. The lid 33 has a box shape with one face opened, and includes a top wall portion 33a, a first side wall portion 33c, a second side wall portion 33d, a third side wall portion 33e, a fourth side wall portion 33f, and an extraction opening 33k.

The bottom plate 32 is disposed along the XZ-plane, and supports one pair of the first light source 41 and the second light source 42 of the pairs of the first light sources 41 and the second light sources 42. The bottom plate 32 includes a base portion 32a and a frame portion 32b. The base portion 32a is a plate-like member forming the main body of the bottom plate 32 and extends to be longer in the X-axis direction. The frame portion 32b is formed integrally with the base portion 32a, and is provided on a surface located at the +Y side of the base portion 32a. The bottom plate 32 has a recessed portion for holding the first light source 41 and the second light source 42.

The bottom plate 32 is coupled to transfer heat to one pair of the first light source 41 and the second light source 42. Accordingly, the bottom plate 32 is desirably formed using a material having a predetermined strength and higher thermal conductivity. As the material of the bottom plate 32, it is desirable to use, for example, a metal such as aluminum or stainless steel, and particularly, 6061 aluminum alloy.

In the lid 33, the top wall portion 33a is disposed along the XZ-plane. The first side wall portion 33c and the second side wall portion 33d cross the X-axis along the longitudinal direction of the light source device 30A and are located at opposite sides to each other in the X-axis direction. The first side wall portion 33c is located at the −X side as one side in the X-axis direction. The second side wall portion 33d is located at the +X side as the other side in the X-axis direction. The third side wall portion 33e and the fourth side wall portion 33f are located at opposite sides to each other in the Z-axis direction crossing the longitudinal direction of the light source device 30A. In the embodiment, the third side wall portion 33e is located at the +Z side as one side in the Z-axis direction. The fourth side wall portion 33f is located at the −Z side as the other side in the Z-axis direction.

The lid 33 holds the other pair of the first light source 41 and the second light source 42 of the pairs of the first light sources 41 and the second light sources 42, the first optical layers 61, the first light guide portions 71, the first wavelength conversion element 51, the second optical layers 62, the second light guide portions 72, the second wavelength conversion element 52, the first reflection member 81, the second reflection members 82, the third reflection members 83, and the fourth optical layer 64. The top wall portion 33a is coupled to transfer heat to the other pair of the first light source 41 and the second light source 42. The third side wall portion 33e and the fourth side wall portion 33f are coupled to transfer heat to the first wavelength conversion element 51 and the second wavelength conversion element 52 via the second reflection members 82 and the third reflection members 83. Accordingly, like the bottom plate 32, the lid 33 is desirably formed using a material having a predetermined strength and higher thermal conductivity. As the material of the lid 33, like the bottom plate, it is desirable to use, for example, a metal such as aluminum or stainless steel, and particularly, 6061 aluminum alloy.

According to the configuration, since the heat of the first wavelength conversion element 51 and the second wavelength conversion element 52 is released to the outside through the lid 33, the temperature rise of the first wavelength conversion element 51 and the second wavelength conversion element 52 can be suppressed. As a result, a decrease in conversion efficiency due to the temperature rise of the first wavelength conversion element 51 and the second wavelength conversion element 52 can be suppressed.

As shown in FIG. 3, the first reflection member 81 is disposed on the first side wall portion 33c of the lid 33. As shown in FIG. 4, the second reflection members 82 are disposed on the third side wall portion 33e and the fourth side wall portion 33f of the lid 33. As shown in FIG. 5, the third reflection members 83 are disposed on the third side wall portion 33e and the fourth side wall portion 33f of the lid 33. The extraction opening 33k is provided in the second side wall portion 33d of the lid 33. The extraction opening 33k is an opening for extracting yellow fluorescence Y and blue fluorescence B emitted from the second light guide portions 72 and the second wavelength conversion element 52 to the outside.

The lid 33 is placed in contact with the base portion 32a of the bottom plate 32. The lid 33 and the bottom plate 32 are fixed to each other via a fixing member such as an adhesive or a screw (not shown). As described above, in the light source device 30A, the respective component elements of the first light sources 41, the first optical layers 61, the first light guide portions 71, the first wavelength conversion element 51, the second light sources 42, the second optical layers 62, the second light guide portions 72, the second wavelength conversion element 52, the first reflection member 81, the second reflection members 82, the third reflection members 83, and the fourth optical layer 64 are held in a space surrounded by the housing 31. Thereby, adhesion of foreign matter such as dust to the above described component elements can be suppressed.

The first light source 41 includes a plurality of first light emitting elements 411. The plurality of first light emitting elements 411 are respectively mounted on the bottom plate 32 and the top wall portion 33a of housing 31. The number of the first light emitting elements 411 provided in the first light source is not particularly limited. The first light emitting element 411 emits a first excitation beam in a first wavelength range. The first light emitting element 411 includes, for example, a light emitting diode (LED). The first light emitting element 411 is disposed to face the first wavelength conversion element 51, and emits the first excitation beam toward the first wavelength conversion element 51. The first wavelength range is, for example, a violet-to-blue wavelength range from 400 nm to 480 nm and has a center wavelength of, for example, 455 nm. The plurality of first light emitting elements 411 are arranged along the X-axis direction as the longitudinal direction of the first wavelength conversion element 51. As described above, the first light source 41 emits a first excitation light E1 in the first wavelength range including a plurality of blue first excitation beams toward the first wavelength conversion element 51. The first excitation light E1 in the embodiment corresponds to a first light in Claims.

The first wavelength conversion element 51 has a columnar shape extending along the X-axis and has six surfaces. The sides of the first wavelength conversion element 51 extending along the X-axis are longer than the sides extending along the Y-axis and the sides extending along the Z-axis. The X-axis direction corresponds to the longitudinal direction of the first wavelength conversion element 51. The Y-axis direction is a direction parallel to the shortest side of the sides of the first wavelength conversion element 51. The lengths of the sides along the Y-axis are shorter than the lengths of the sides along the Z-axis. That is, the cross-sectional shape of the first wavelength conversion element 51 cut along a plane along the YZ-plane is a rectangular shape as shown in FIG. 4.

The first wavelength conversion element 51 includes a front surface 51a and a back surface 51b, a first end surface 51c and a second end surface 51d, and a first side surface 51e and a second side surface 51f. The front surface 51a and the back surface 51b cross the Y-axis and face opposite sides to each other in the Y-axis. In the embodiment, the front surface 51a is a surface located at the +Y side as one side in the Y-axis direction. The back surface 51b is a surface located at the −Y side as the other side in the Y-axis direction. The first excitation light E1 enters the front surface 51a from the first light source 41 disposed on the top wall portion 33a via the first optical layer 61 and the first light guide portion 71. The first excitation light E1 enters the back surface 51b from the first light source 41 disposed on the bottom plate 32 via the first optical layer 61 and the first light guide portion 71. The front surface 51a of the embodiment corresponds to a first surface in Claims.

As shown in FIG. 3, the first end surface 51c and the second end surface 51d cross the front surface 51a and the back surface 51b, and face opposite sides to each other in the X-axis direction along the longitudinal direction of the first wavelength conversion element 51. In the embodiment, the first end surface 51c is located at the −X side as one side in the X-axis direction. The second end surface 51d is located at the +X side as the other side in the X-axis direction. The first end surface 51c of the embodiment corresponds to a second surface in Claims. The second end surface 51d of the embodiment corresponds to a third surface in Claims.

As shown in FIG. 4, the first side surface 51e and the second side surface 51f cross the front surface 51a and the back surface 51b and the first end surface 51c and the second end surface 51d, and face opposite sides to each other in the Z-axis direction. In the embodiment, the first side surface 51e is located at the +Z side as one side in the Z-axis direction, and the second side surface 51f is located at the −Z side as the other side in the Z-axis direction. The first side surface 51e of the embodiment corresponds to a seventh surface in Claims. The second side surface 51f of the embodiment corresponds to an eighth surface in Claims.

The first wavelength conversion element 51 contains at least yellow phosphor, and converts the first excitation light E1 in the first wavelength range emitted from the first light source 41 into yellow fluorescence Y in a second wavelength range different from the first wavelength range. As will be described in detail later, part of the yellow fluorescence Y generated inside the first wavelength conversion element 51 is emitted from the front surface 51a and the back surface 51b to the first light guide portions 71.

The first wavelength conversion element 51 contains ceramic phosphor including polycrystalline phosphor for wavelength-conversion of the first excitation light E1 into yellow fluorescence Y. The first wavelength conversion element 51 of the embodiment is formed using phosphor without a light scattering property, the so-called transparent phosphor. The second wavelength range of the yellow fluorescence Y is a yellow wavelength range, for example, from 490 to 750 nm. The center wavelength of the second wavelength range is, for example, 550 nm. That is, the fluorescence Y is yellow fluorescence containing a red light component and a green light component. The yellow fluorescence Y of the embodiment corresponds to a second light in Claims.

The first wavelength conversion element 51 may include single crystal phosphor instead of the polycrystalline phosphor. Or, the first wavelength conversion element 51 may include fluorescent glass. Or, the first wavelength conversion element 51 may be formed using a material obtained by dispersion of a large number of phosphor particles in a binder of glass or resin. The first wavelength conversion element 51 formed using the material converts the first excitation light E1 into yellow fluorescence Y.

Specifically, the material of the first wavelength conversion element 51 includes, for example, yttrium aluminum garnet (YAG)-based phosphor. YAG:Ce containing cerium (Ce) as an activator is taken as an example. As the material of the first wavelength conversion element 51, a material obtained by mixing and solid-phase reaction of raw powder containing constituent elements such as Y₂O₃, Al₂O₃, CeO₃, Y—Al—O amorphous particles obtained by a wet process such as a coprecipitation process or a sol-gel process, YAG particles obtained by a gas-phase process such as a spray-drying process, a flame pyrolysis process, or a thermal plasma process, or the like is used.

The first optical layers 61 are disposed between the first light sources 41 and the first wavelength conversion element 51. Specifically, the first optical layers 61 are respectively disposed between the first light source 41 at the bottom plate 32 side and the first wavelength conversion element 51, and between the first light source 41 at the top wall portion 33a side and the first wavelength conversion element 51. The first optical layer 61 has an optical property of transmitting the first excitation light E1 and reflecting yellow fluorescence Y. The first optical layer 61 includes, for example, a dielectric multilayer film. The first optical layer 61 is disposed on a surface of the first light-transmissive member 73, which will be described later, facing the first light source 41.

The first light guide portions 71 are disposed between the first optical layers 61 and the first wavelength conversion element 51. Specifically, the first light guide portions 71 are respectively disposed between the first optical layer 61 at the side closer to the bottom plate 32 and the first wavelength conversion element 51, and between the first optical layer 61 at the side closer to the top wall portion 33a and the first wavelength conversion element 51. The first light guide portion 71 guides the yellow fluorescence Y converted by the first wavelength conversion element 51. In the embodiment, the first light-transmissive member 73 that transmits the first excitation light E1 and the yellow fluorescence Y is disposed in the first light guide portion 71. The first light-transmissive members 73 are bonded to the front surface 51a and the back surface 51b of the first wavelength conversion element 51 by optical adhesives.

The first light-transmissive member 73 is formed using a light-transmissive material including, for example, borosilicate glass such as BK7, quartz, synthetic quartz, quartz crystal, SiC, GaN, MgO, YAG, sapphire, and diamond. As described above, it is necessary to form the first light-transmissive member 73 using a material that can transmit the first excitation light E1 and the yellow fluorescence Y. The first light-transmissive member 73 has a plate shape extending along the X-axis. As shown in FIG. 4, the cross-sectional shape of the first light-transmissive member 73 cut along a plane along the YZ-plane is a rectangular shape extending to be longer in the X-axis direction.

It is desirable that the thermal conductivity of the first light-transmissive member 73 is higher than the thermal conductivity of the first wavelength conversion element 51. The material of the first light-transmissive member 73 that satisfies the relationship includes, for example, SiC, GaN, MgO, YAG, sapphire, and diamond. According to the configuration, since the heat of the first wavelength conversion element 51 is efficiently transferred to the first light-transmissive members 73, the temperature rise of the first wavelength conversion element 51 can be suppressed. Thereby, a decrease in conversion efficiency due to the temperature rise of the first wavelength conversion element 51 can be suppressed.

As shown in FIG. 3, the first reflection member 81 is disposed at the −X side of the first wavelength conversion element 51, the first light guide portions 71, the first optical layers 61, and the first light sources 41. Specifically, the first reflection member 81 is provided on the first side wall portion 33c of the housing 31 to face the first end surface 51c of the first wavelength conversion element 51, regions of the first light guide portions 71 at the first end surface 51c side, end surfaces of the first optical layers 61 at the first end surface 51c side, and regions of the first light sources 41 at the first end surface 51c side. The first reflection member 81 is not necessarily provided all over the above described regions, but may be provided at least in the regions at the first end surface 51c side of the first light guide portions 71.

The first reflection member 81 reflects the yellow fluorescence Y propagating inside the first light guide portion 71 and the first wavelength conversion element 51 and reaching the first reflection member 81. Further, the first reflection member 81 reflects the first excitation light E1 reflected by the front surface 51a of the first wavelength conversion element 51, propagating through the first light guide portion 71, and reaching the first reflection member 81. That is, the first reflection member 81 reflects the yellow fluorescence Y and the first excitation light E1. The first reflection member 81 includes, for example, a metal film, a dielectric multilayer film, or a scattering member containing barium sulfate.

As shown in FIG. 4, the pair of second reflection members 82 are disposed on both sides in the Z-axis direction of the first optical layers 61, the first light guide portions 71, and the first wavelength conversion element 51. One second reflection member 82 is disposed on the third side wall portion 33e of the housing 31 to face the first wavelength conversion element 51 at the first side surface 51e side and the regions of the first light guide portions 71 at the first side surface 51e. The other second reflection member 82 is disposed on the fourth side wall portion 33f of the housing 31 to face the first wavelength conversion element 51 at the second side surface 51f side and the regions of the first light guide portions 71 at the second side surface 51f side.

The second reflection member 82 reflects the yellow fluorescence Y and the first excitation light E1. Accordingly, the second reflection member 82 reflects the first excitation light E1 reflected by the front surface 51a of the first wavelength conversion element 51, entering the first light guide portion 71, and reaching the second reflection member 82, and enters the light into the first wavelength conversion element 51. Thereby, the conversion efficiency from the first excitation light E1 to the yellow fluorescence Y can be increased. Further, the second reflection member 82 reflects the yellow fluorescence Y emitted from the first wavelength conversion element 51, entering the first light guide portion 71, and reaching the second reflection member 82 and the yellow fluorescence Y guided inside the first wavelength conversion element 51 and reaching the second reflection member 82. Thereby, the loss of the yellow fluorescence Y can be suppressed. The second reflection member 82 includes, for example, a metal film, a dielectric multilayer film, or a scattering member.

As shown in FIG. 3, the second light source 42 includes a plurality of second light emitting elements 421. The plurality of second light emitting elements 421 are respectively mounted in regions at the +X side of the plurality of first light emitting elements 411 in the bottom plate 32 and the top wall portion 33a of the housing 31. Note that the number of the second light emitting elements 421 is not particularly limited. The second light emitting element 421 emits a second excitation beam in a third wavelength range. The second light emitting element 421 includes, for example, an LED. The second light emitting element 421 is disposed to face the second wavelength conversion element 52, and emits the second excitation beam toward the second wavelength conversion element 52. The third wavelength range is, for example, an ultraviolet wavelength range, and the center wavelength is, for example, 380 nm. The plurality of second light emitting elements 421 are arranged along the X-axis direction as the longitudinal direction of the second wavelength conversion element 52. As described above, the second light source 42 emits a second excitation light E2 in the third wavelength range including a plurality of ultraviolet second excitation beams toward the second wavelength conversion element 52. The second excitation light E2 of the embodiment corresponds to a third light in Claims.

The second wavelength conversion element 52 is disposed at the +X side of the first wavelength conversion element 51. The second wavelength conversion element 52 has a columnar shape extending along the X-axis and has six surfaces. The sides of the second wavelength conversion element 52 extending along the X-axis are longer than the sides extending along the Y-axis and the sides extending along the Z-axis. The X-axis direction corresponds to the longitudinal direction of the second wavelength conversion element 52. The Y-axis direction is a direction parallel to the shortest side of the sides of the second wavelength conversion element 52. The lengths of the sides along the Y-axis are shorter than the lengths of the sides along the Z-axis. That is, the cross-sectional shape of the second wavelength conversion element 52 cut along a plane along the YZ-plane is a rectangular shape as shown in FIG. 5.

The second wavelength conversion element 52 has a front surface 52a and a back surface 52b, a first end surface 52c and a second end surface 52d, and a first side surface 52e and a second side surface 52f. The front surface 52a and the back surface 52b cross the Y-axis and face opposite sides to each other in the Y-axis. In the embodiment, the front surface 52a is a surface located at the +Y side as one side in the Y-axis direction. The back surface 52b is a surface located at the −Y side as the other side in the Y-axis direction. The second excitation light E2 enters the front surface 52a from the second light source 42 disposed on the top wall portion 33a via the second optical layer 62 and the second light guide portion 72. The second excitation light E2 enters the back surface 52b from the second light source 42 disposed on the bottom plate 32 via the second optical layer 62 and the second light guide portion 72. The front surface 52a of the embodiment corresponds to a fourth surface in Claims.

As shown in FIG. 3, the first end surface 52c and the second end surface 52d cross the front surface 52a and the back surface 52b, and face opposite sides to each other in the X-axis direction along the longitudinal direction of the second wavelength conversion element 52. In the embodiment, the first end surface 52c is located at the −X side as one side in the X-axis direction, and faces the second end surface 51d of the first wavelength conversion element 51. The second end surface 52d is located at the +X side as the other side in the X-axis direction. The first end surface 52c of the embodiment corresponds to a fifth surface in Claims. The second end surface 52d of the embodiment corresponds to a sixth surface in Claims.

As shown in FIG. 5, the first side surface 52e and the second side surface 52f cross the front surface 52a and the back surface 52b and the first end surface 52c and the second end surface 52d, and face opposite sides to each other in the Z-axis direction. In the embodiment, the first side surface 52e is located at the +Z side as one side in the Z-axis direction, and the second side surface 52f is located at the −Z side as the other side in the Z-axis direction. The first side surface 52e of the embodiment corresponds to a ninth surface in Claims. The second side surface 52f of the embodiment corresponds to a tenth surface in Claims.

The second wavelength conversion element 52 contains at least blue phosphor, and converts the second excitation light E2 in the third wavelength range emitted from the plurality of second light emitting elements 421 of the second light source 42 into blue fluorescence B in a fourth wavelength range different from the third wavelength range or the second wavelength range. As will be described in detail later, part of the blue fluorescence B generated inside the second wavelength conversion element 52 is emitted from the front surface 52a and the back surface 52b to the second light guide portions 72.

The second wavelength conversion element 52 includes phosphor for wavelength-conversion of the second excitation light E2 into blue fluorescence B. The phosphor includes (Sr, Ba)₁₀(PO₄)₆Cl₂:Eu²⁺ (SBCA) as an example. The second wavelength conversion element 52 of the embodiment is formed using phosphor without a light scattering property, the so-called transparent phosphor. The fourth wavelength range of the blue fluorescence B is, for example, a blue wavelength range from 430 to 490 nm. The center wavelength of the fourth wavelength range is, for example, 460 nm. The blue fluorescence B of the embodiment corresponds to a fourth light in Claims. As the material of the second wavelength conversion element 52, BaMgAl₁₀O₁₇:Eu(II) or the like may be used.

The second optical layers 62 are disposed between the second light sources 42 and the second wavelength conversion element 52. Specifically, the second optical layers 62 are respectively disposed between the second light source 42 at the bottom plate 32 side and the second wavelength conversion element 52, and between the second light source 42 at the top wall portion 33a side and the second wavelength conversion element 52. The second optical layer 62 has an optical property of transmitting the second excitation light E2 and reflecting the blue fluorescence B. The second optical layer 62 includes, for example, a dielectric multilayer film. The second optical layers 62 are disposed on surfaces of second light-transmissive members 74, which will be described later, facing the second light sources 42.

In the embodiment, the second optical layer 62 transmits the second excitation light E2 and reflects the blue fluorescence B, and reflects the yellow fluorescence Y. Accordingly, the yellow fluorescence Y converted by the first wavelength conversion element 51 is reflected by the second optical layer 62 when propagating inside the second light guide portion 72. Thereby, the yellow fluorescence Y emitted from the second light guide portion 72 to the second light source 42 side does not result in a loss, and the use efficiency of the yellow fluorescence Y can be maintained.

The second light guide portions 72 are disposed between the second optical layers 62 and the second wavelength conversion element 52. Specifically, the second light guide portions 72 are respectively disposed between the second optical layer 62 at the side closer to the bottom plate 32 and the second wavelength conversion element 52, and between the second optical layer 62 at the side closer to the top wall portion 33a and the second wavelength conversion element 52. The second light guide portion 72 guides the blue fluorescence B converted by the second wavelength conversion element 52 and the yellow fluorescence Y converted by the first wavelength conversion element 51. In the embodiment, the second light-transmissive member 74 that transmits the second excitation light E2, the blue fluorescence B, and the yellow fluorescence Y is disposed in the second light guide portion 72. The second light-transmissive members 74 are bonded to the front surface 52a and the back surface 52b of the second wavelength conversion element 52 by optical adhesives.

The second light-transmissive member 74 is formed using a light-transmissive material including, for example, borosilicate glass such as BK7, quartz, synthetic quartz, quartz crystal, SiC, GaN, MgO, YAG, sapphire, and diamond. As described above, it is necessary to form the second light-transmissive member 74 using a material that can transmit the second excitation light E2, the blue fluorescence B, and the yellow fluorescence Y. The second light-transmissive member 74 has a plate shape extending along the X-axis. As shown in FIG. 5, the cross-sectional shape of the second light-transmissive member 74 cut along a plane along the YZ-plane is a rectangular shape extending to be longer in the X-axis direction. The constituent material of the second light-transmissive member 74 may be the same as or different from the constituent material of the first light-transmissive member 73.

It is desirable that the thermal conductivity of the second light-transmissive member 74 is higher than the thermal conductivity of the second wavelength conversion element 52. The material of the second light-transmissive member 74 that satisfies the relationship includes SiC, GaN, MgO, YAG, sapphire, and diamond. According to the configuration, since the heat of the second wavelength conversion element 52 is efficiently transferred to the second light-transmissive member 74, the temperature rise of the second wavelength conversion element 52 can be suppressed. Thereby, a decrease in conversion efficiency due to the temperature rise of the second wavelength conversion element 52 can be suppressed.

As shown in FIG. 5, the pair of third reflection members 83 are disposed on both sides in the Z-axis direction of the second optical layers 62, the second guiding portions 72, and the second wavelength converting element 52. One third reflection member 83 is disposed on the third side wall portion 33e of the housing 31 to face the second wavelength conversion element 52 at the first side surface 52e side and the regions of the second light guide portions 72 at the first side surface 52e side. The other third reflection member 83 is disposed on the fourth side wall portion 33f of the housing 31 to face the second wavelength conversion element 52 at the second side surface 52f side and the regions of the second light guide portions 72 at the second side surface 52f side.

The third reflection member 83 reflects the blue fluorescence B and the second excitation light E2. Accordingly, the third reflection member 83 reflects the second excitation light E2 reflected by the front surface 52a of the second wavelength conversion element 52, entering the second light guide portion 72, and reaching the third reflection member 83, and enters the light into the second wavelength conversion element 52. Thereby, the conversion efficiency from the second excitation light E2 to the blue fluorescence B can be increased. In addition, the third reflection member 83 reflects the blue fluorescence B emitted from the second wavelength conversion element 52, entering the second light guide portion 72, and reaching the third reflection member 83 and the blue fluorescence B guided inside the second wavelength conversion element 52 and reaching the third reflection member 83. Thereby, the loss of the blue fluorescence B can be suppressed. The third reflection member 83 includes, for example, a metal film, a dielectric multilayer film, or a scattering member. Furthermore, the third reflection member 83 reflects the yellow fluorescence Y converted by the first wavelength conversion element 51. Thereby, the loss of the yellow fluorescence Y can also be suppressed.

As shown in FIG. 3, the fourth optical layer 64 is disposed between the first light guide portions 71 and the second light guide portions 72. Specifically, the fourth optical layer 64 is disposed over between the second end surface 51d of the first wavelength conversion element 51 and the first end surface 52c of the second wavelength conversion element 52, between the regions of the first light guide portions 71 at the second end surface 51d side and the regions of the second light guide portions 72 at the first end surface 52c side, between the regions of the first optical layers 61 at the second end surface 51d side and the regions of the second optical layers 62 at the first end surface 52c side, and between the first light sources 41 and the second light sources 42. The fourth optical layer 64 is not necessarily provided all over the above described regions, but may be provided at least in the regions of the first light guide portions 71 at the second end surface 51d side and the regions of the second light guide portion 72 at the first end surface 52c side. The fourth optical layer 64 has an optical property of transmitting the yellow fluorescence Y and reflecting the second excitation light E2 and the blue fluorescence B. The fourth optical layer 64 includes a dielectric multilayer film formed on one surface of a light-transmissive member. Further, the fourth optical layer 64 of the embodiment is formed on the surface of the light-transmissive member (not shown) and is fixed to the housing 31.

As shown in FIG. 1, the optical integration system 90 is provided at the light exiting side of the light source device 30A. The optical integration system 90 includes a first lens array 91 and a second lens array 92. The optical integration system 90, along with the superimposing system 94, functions as a homogeneous illumination system that homogenizes the intensity distribution of the white light LW emitted from the light source device 30A in the respective light modulation devices 400R, 400G, 400B as illuminated regions. The white light LW emitted from the light source device 30A enters the first lens array 91.

The first lens array 91 includes a plurality of first lenses 91a. The plurality of first lenses 91a are arranged in a matrix form in a plane parallel to the YZ-plane orthogonal to the optical axis AX1 of the illumination device 20. The plurality of first lenses 91a divide the white light LW emitted from the light source device 30A into a plurality of partial luminous fluxes. The shapes of the respective first lenses 91a are rectangular shapes substantially similar to the shapes of the image formation areas of the light modulation devices 400R, 400G, 400B. Accordingly, the respective partial luminous fluxes emitted from the first lens array 91 efficiently enter the image formation areas of the light modulation devices 400R, 400G, 400B.

The white light LW emitted from the first lens array 91 travels toward the second lens array 92. The second lens array 92 is disposed to face the first lens array 91. The second lens array 92 includes a plurality of second lenses 92a corresponding to the plurality of first lenses 91a of the first lens array 91. The second lens array 92, along with the superimposing system 94, forms respective images of the plurality of first lenses 91a of the first lens array 91 in the vicinities of the image formation areas of the light modulation devices 400R, 400G, 400B. The plurality of second lenses 92a are arranged in a matrix form in a plane parallel to the YZ-plane orthogonal to the optical axis AX1 of the illumination device 20. The superimposing system 94 includes a single convex lens.

In the embodiment, each first lens 91a of the first lens array 91 and each second lens 92a of the second lens array 92 have the same size as each other, however, may have different sizes from each other. Further, in the embodiment, the first lenses 91a of the first lens array 91 and the second lenses 92a of the second lens array 92 are arranged in positions where the optical axes thereof are aligned with each other, however, may be arranged in positions where the optical axes thereof deviate from each other.

The polarization conversion element 93 converts the polarization direction of the white light LW emitted from the second lens array 92. Specifically, the polarization conversion element 93 converts each of the partial luminous fluxes of the white light LW divided by the first lens array 91 and then emitted from the second lens array 92 into a linearly-polarized light. The polarization conversion element 93 includes a polarization separation layer (not shown), a reflection layer (not shown), and a retardation layer (not shown). The polarization separation layer transmits one linearly-polarized component of the polarization components contained in the white light LW emitted from the light source device 30A without change, and reflects the other linearly-polarized component in a direction perpendicular to the optical axis AX1. The reflection layer reflects the other linearly-polarized component reflected by the polarization separation layer in a direction parallel to the optical axis AX1. The retardation layer converts the other linearly-polarized component reflected by the reflection layer into the one linearly-polarized component.

As below, a behavior of light in the light source device 30A of the embodiment will be described.

As shown in FIG. 3, in the light source device 30A, the first excitation light E1 emitted from the first light source 41 is transmitted through the first optical layer 61 and the first light-transmissive member 73 and enters the first wavelength conversion element 51. Note that part of the first excitation light E1 is backscattered by the front surface 51a and the back surface of the first wavelength conversion element 51 and travels toward the first light source 41 sides, and is reflected by the first optical layer 61 or the first light-transmissive member 73 and then enters the first wavelength conversion element 51.

When the first excitation light E1 enters the first wavelength conversion element 51, the phosphor contained in the first wavelength conversion element 51 is excited, and yellow fluorescence Y is emitted from a certain light emission point. Concurrently, the first excitation light E1 entering the phosphor is diffused and propagates to a region wider than the incident region, and thereby, the so-called blurring of the yellow fluorescence Y that the width of the emission region of the yellow fluorescence Y becomes wider occurs.

The yellow fluorescence Y entering the front surface 51a and the back surface 51b of the first wavelength conversion element 51 at an incidence angle smaller than the critical angle is emitted from the first wavelength conversion element 51, enters the first light-transmissive member 73, and propagates inside the first light-transmissive member 73. Here, the fluorescence Y1 traveling toward the +X side is reflected by the first optical layer 61 and enters the first wavelength conversion element 51 again. In the embodiment, since the first wavelength conversion element 51 is formed using transparent phosphor, scattering of the yellow fluorescence Y does not occur inside the first wavelength conversion element 51, and the traveling direction of yellow fluorescence Y1 is not changed inside the first wavelength conversion element 51. Accordingly, the yellow fluorescence Y1 enters the first light-transmissive member 73 from the back surface 51b of the first wavelength conversion element 51, and is emitted from the region of the first light-transmissive member 73 at the second end surface 51d side.

Of the yellow fluorescence Y emitted from the first wavelength conversion element 51, yellow fluorescence Y0 perpendicularly entering the first optical layer 61 is repeatedly reflected between the two first optical layers 61 because the first wavelength conversion element 51 is formed using the transparent phosphor and the traveling direction of the yellow fluorescence Y0 is not changed inside the first wavelength conversion element 51.

Yellow fluorescence Y2 entering at an incidence angle equal to or larger than the critical angle with respect to the front surface 51a and the back surface of the first wavelength conversion element 51 is totally reflected by the front surface 51a and the back surface 51b of the first wavelength conversion element 51. Here, in the embodiment, the first wavelength conversion element 51 is formed using the transparent phosphor and the traveling direction of the yellow fluorescence Y2 is not changed inside the first wavelength conversion element 51, and thereby, incidence angle of the yellow fluorescence Y2 with respect to the front surface 51a and the back surface 51b of the first wavelength conversion element 51 is not changed. The yellow fluorescence Y2 is repeatedly totally reflected by the front surface 51a and the back surface 51b of the first wavelength conversion element 51, and emitted from the second end surface 51d.

That is, the yellow fluorescence Y propagates inside the first light-transmissive member 73 and the first wavelength conversion element 51 while being repeatedly reflected by the front surface 51a and the back surface 51b of the first wavelength conversion element 51 and reflected by the first optical layers 61, and is emitted from the region of the first light-transmissive member 73 at the second end surface 51d side or the second end surface 51d of the first wavelength conversion element 51.

On the other hand, yellow fluorescence Y3, Y4 traveling toward the −X side and reaching the first reflection member 81 is reflected by the first reflection member 81, then, travels toward the +X side, and follows the same route as that of the above described yellow fluorescence Y1, Y2. That is, the yellow fluorescence Y3, Y4 propagates inside the first light-transmissive members 73 and the first wavelength conversion element 51 while being repeatedly reflected between the first optical layers 61 and the front surface 51a or the back surface 51b of the first wavelength conversion element 51, and is emitted from the region of the first light-transmissive member 73 at the second end surface 51d side or the second end surface 51d of the first wavelength conversion element 51.

Then, the yellow fluorescence Y1, Y2, Y3, Y4 emitted from the regions of the first light-transmissive member 73 at the second end surface 51d side or the second end surface 51d of the first wavelength conversion element 51 is transmitted through the fourth optical layer 64 and enters the region of the second light-transmissive member 74 at the first end surface 52c side or the first end surface 52c of the second wavelength conversion element 52.

On the other hand, the blue fluorescence B converted by the second wavelength conversion element 52 exhibits the same behavior as the above described yellow fluorescence Y.

The second excitation light E2 emitted from the second light source 42 is transmitted through the second optical layer 62 and the second light-transmissive member 74 and enters the second wavelength conversion element 52. Part of the second excitation light E2 is backscattered by the front surface 52a and the back surface 52b of the second wavelength conversion element 52 and travels toward the second light source 42 side, and is reflected by the second optical layer 62 or the second light-transmissive member 74 and then enters the second wavelength conversion element 52.

When the second excitation light E2 enters the second wavelength conversion element 52, the phosphor contained in the second wavelength conversion element 52 is excited, and blue fluorescence B is emitted from a certain light emission point. Concurrently, the second excitation light E2 entering the phosphor is diffused and propagates to a region wider than the incident region, and thereby, the so-called blurring of the blue fluorescence B that the width of the emission region of the blue fluorescence B becomes wider occurs.

The blue fluorescence B entering at an incidence angle smaller than the critical angle with respect to the front surface 52a and the back surface 52b of the second wavelength conversion element 52 is emitted from the second wavelength conversion element 52, enters the second light-transmissive member 74, and propagates inside the second light-transmissive member 74. Here, blue fluorescence B1 traveling toward the +X side is reflected by the second optical layer 62 and enters the second wavelength conversion element 52 again. In the embodiment, since the second wavelength conversion element 52 is formed using transparent phosphor, scattering of the blue fluorescence B1 does not occur inside the second wavelength conversion element 52, and the traveling direction of the blue fluorescence B1 is not changed. Accordingly, the blue fluorescence B1 enters the second light-transmissive member 74 from the back surface 52b of the second wavelength conversion element 52, and is emitted from the region of the second light-transmissive member 74 at the second end surface 52d side.

Of the blue fluorescence B emitted from the second wavelength conversion element 52, blue fluorescence BC perpendicularly entering the second optical layer 62 is repeatedly reflected between the two second optical layers 62 because the second wavelength conversion element 52 is formed using the transparent phosphor and the traveling direction of the blue fluorescence BC is not changed inside the second wavelength conversion element 52.

Blue fluorescence B2 entering the front surface 52a and the back surface 52b of the second wavelength conversion element 52 at an incidence angle equal to or larger than the critical angle is totally reflected by the front surface 52a and the back surface 52b of the second wavelength conversion element 52. Here, the second wavelength conversion element 52 is formed using the transparent phosphor and the traveling direction of the blue fluorescence B2 is not changed inside the second wavelength conversion element 52, and thereby, the incidence angle of the blue fluorescence B2 with respect to the front surface 52a and the back surface 52b of the second wavelength conversion element 52 is not changed. Accordingly, the blue fluorescence B2 is repeatedly totally reflected by the front surface 52a and the back surface 52b of the second wavelength conversion element 52, and is emitted from the second end surface 52d.

That is, the blue fluorescence B propagates inside the second light-transmissive member 74 and the second wavelength conversion element 52 while being repeatedly reflected by the front surface 52a and the back surface 52b of the second wavelength conversion element 52 and reflected by the second optical layer 62, and is emitted from the region of the second light-transmissive member 74 at the second end surface 52d side and the second end surface 52d of the second wavelength conversion element 52.

On the other hand, blue fluorescence B3, B4 traveling toward the −X side and reaching the fourth optical layers 64 is reflected by the fourth optical layer 64, then, travels toward the +X side, and follows the same route as that of the above described blue fluorescence B1, B2. If the fourth optical layers 64 are not provided, part of the blue fluorescence B3, B4 traveling toward the −X side enters the first wavelength conversion element 51 and is absorbed by the yellow phosphor of the first wavelength conversion element 51. Thereby, part of the blue fluorescence B3, B4 may result in a loss and the use efficiency of the blue fluorescence B may be lower. Therefore, according to the light source device 30A of the embodiment including the fourth optical layers 64, absorption of part of the blue fluorescence B converted by the second wavelength conversion element 52 by the phosphor of the first wavelength conversion element 51 is suppressed, and the use efficiency of the blue fluorescence B can be maintained.

The yellow fluorescence Y1, Y2 transmitted through the fourth optical layer 64 and entering the second light-transmissive member 74 or the second wavelength conversion element 52 propagates inside the second light-transmissive member 74 or the second wavelength conversion element 52, and then, is emitted from the region of the second light-transmissive member 74 at the second end surface 52d side or the second end surface 52d of the second wavelength conversion element 52. Specifically, the yellow fluorescence Y1 entering the second wavelength conversion element 52 from the first light-transmissive member 73 via the fourth optical layer 64 and the second light-transmissive member 74 enters the front surface 52a of the second wavelength conversion element 52 at an incidence angle smaller than the critical angle, and thus, a behavior that the fluorescence is emitted from the second wavelength conversion element 52 to the second light-transmissive member 74, then, reflected by the second optical layer 62, and re-enters the second wavelength conversion element 52 is repeated. Then, the yellow fluorescence Y1 is emitted from the region of the second light-transmissive member 74 at the second end surface 52d side.

On the other hand, the yellow fluorescence Y4 entering the second wavelength conversion element 52 from the first wavelength conversion element 51 via the fourth optical layer 64 enters the front surface of the second wavelength conversion element 52 at an incidence angle equal to or larger than the critical angle, and thus, the fluorescence propagates inside the second wavelength conversion element 52 while being repeatedly totally reflected by the front surface 52a and the back surface 52b of the second wavelength conversion element 52. Then, the yellow fluorescence Y4 is emitted from the second end surface 52d of the second wavelength conversion element 52. As described above, the blue fluorescence B converted by the second wavelength conversion element 52 and the yellow fluorescence Y emitted from the region at the second end surface 51d side travel inside the second light guide portion 72 or the second wavelength conversion element 52, and are emitted from the region of the second light guide portion 72 at the second end surface 52d side or the second end surface 52d of the second wavelength conversion element 52. Thereby, the light source device 30A can emit the white light LW containing the yellow fluorescence Y generated in the first wavelength conversion element 51 and the blue fluorescence B generated in the second wavelength conversion element 52 to the outside from the extraction opening 33k of the housing 31.

As shown in FIG. 2, in a plan view in the X-axis direction as the normal direction of the second end surface 52d of the second wavelength conversion element 52, the extraction opening 33k overlaps with the second light guide portions 72 and the second wavelength conversion element 52. Accordingly, the regions of the second light guide portions 72 at the second end surface 52d side and the second end surface 52d of the second wavelength conversion element 52 are exposed to the outside through the extraction opening 33k. The extraction opening 33k may be closed by a lid including a light-transmissive member not to expose the regions of the second light guide portions 72 at the second end surface 52d side and the second end surface 52d of the second wavelength conversion element 52 to the outside. However, when the lid is provided, some of the yellow fluorescence Y and the blue fluorescence B may be reflected by the surface of the lid and not be extracted to the outside. Therefore, it is desirable not to provide the lid in order to increase the extraction efficiency of the yellow fluorescence Y and the blue fluorescence B. In the example of FIG. 2, the extraction opening 33k overlaps with not only the second light guide portions and the second wavelength conversion element 52 but also the second optical layers 62, however, the opening does not necessarily overlap with the second optical layers 62.

As described above, from the light source device 30A, the white light LW emitted from the regions of the second light guide portions 72 at the second end surface 52d side and the second end surface 52d of the second wavelength conversion element 52 can be extracted to the outside through the minimum extraction opening 33k. Thereby, etendue of the white light LW is smaller in the light source device 30A, and the loss of the white light LW in the optical members including the optical integration system 90 disposed downstream of the light source device 30A can be reduced. As a result, the use efficiency of the white light LW in the light source device 30A can be increased.

In addition, the ratio between the length of the first wavelength conversion element 51 and the length of the second wavelength conversion element 52 along the arrangement direction (X-axis direction) in which the first wavelength conversion element 51 and the second wavelength conversion element 52 are arranged is changed, and thereby, the ratio between the amount of the yellow fluorescence Y converted by the first wavelength conversion element 51 and the amount of the blue fluorescence B converted by the second wavelength conversion element 52 can be changed. Accordingly, the color temperature of the white light LW emitted from the light source device 30A can be adjusted. As a result, the color of the image projected from the projector 10 can be adjusted. The ratio between the amount of the first excitation light E1 from the first light source 41 and the amount of the second excitation light E2 from the second light source 42 is changed, and thereby, the color temperature of the white light LW may be adjusted.

Since the first wavelength conversion element 51 is farther from the extraction opening 33k than the second wavelength conversion element 52, the yellow fluorescence Y passes through a path longer than that of the blue fluorescence B and reaches the extraction opening 33k. Accordingly, the loss of the yellow fluorescence Y tends to be larger than that of the blue fluorescence B. From this viewpoint, it is desirable that the length of the first wavelength conversion element 51 along the arrangement direction (X-axis direction) in which the first wavelength conversion element 51 and the second wavelength conversion element 52 are arranged is larger than the length of the second wavelength conversion element 52. Thereby, the amount of the yellow fluorescence Y can be relatively increased to the amount of the blue fluorescence B, and the white light LW having a desired color temperature can be easily obtained.

### Effects of First Embodiment

The light source device 30A of the embodiment includes the first light sources 41 emitting the first excitation light E1, the first wavelength conversion element 51 converting the first excitation light E1 into the yellow fluorescence Y, the first optical layers 61 disposed between the first light sources 41 and the first wavelength conversion element 51 and transmitting the first excitation light E1 and reflecting the yellow fluorescence Y, the first light guide portions 71 disposed between the first optical layers 61 and the first wavelength conversion element 51 and guiding the yellow fluorescence Y converted by the first wavelength conversion element 51, the second light sources 42 emitting the second excitation light E2, the second wavelength conversion element 52 converting the second excitation light E2 into the blue fluorescence B, the second optical layers 62 disposed between the second light sources 42 and the second wavelength conversion element 52 and transmitting the second excitation light E2 and reflecting the blue fluorescence B, the second light guide portions 72 disposed between the second optical layers 62 and the second wavelength conversion element 52 and guiding the blue fluorescence B converted by the second wavelength conversion element 52, and the first reflection member 81 reflecting the first excitation light E1 and the yellow fluorescence Y. The first wavelength conversion element 51 includes the front surface 51a and the back surface 51b entered by the first excitation light E1 via the first optical layers 61 and the first light guide portions 71, and the first end surface 51c and the second end surface 51d crossing the front surface 51a and the back surface 51b and facing opposite sides to each other. The second wavelength conversion element 52 includes the front surface 52a and the back surface 52b entered by the second excitation light E2 via the second optical layers 62 and the second light guide portions 72, and the first end surface 52c and the second end surface 52d crossing the front surface 52a and the back surface 52b and facing opposite sides to each other. The first reflection member 81 is disposed in the region at the first end surface 51c side of the first light guide portions 71. The yellow fluorescence Y converted by the first wavelength conversion element 51 travels through the first light guide portion 71, is emitted from the region of the first light guide portion 71 at the second end surface 51d side, and enters the region of the second light guide portion 72 at the first end surface 52c side, and the blue fluorescence B converted by the second wavelength conversion element 52 and the yellow fluorescence Y emitted from the region at the second end surface 51d side travel through the second light guide portion 72 and are emitted from the region of the second light guide portion 72 at the second end surface 52d side.

As described above, according to the light source device 30A of the embodiment, part of the yellow fluorescence Y generated in the first wavelength conversion element 51 and part of the blue fluorescence B generated in the second wavelength conversion element 52 travel through the second light guide portion 72 and are emitted from the region of the second light guide portion 72 at the second end surface 52d side. Therefore, for example, as compared with the light source device of related art in which all the fluorescence propagates inside the wavelength conversion elements, the loss of the yellow fluorescence Y and the blue fluorescence B is smaller, and the use efficiency of the yellow fluorescence Y and the blue fluorescence B can be increased. Further, the light source device 30A of the embodiment can efficiently emit white light LW formed by combination of yellow fluorescence Y and blue fluorescence B.

The projector 10 of the embodiment includes the light source device 30A, the light modulation devices 400R, 400G, 400B that modulate the light emitted from the light source device 30A, and the projection optical device 600 that projects the lights modulated by the light modulation devices 400R, 400G, 400B.

According to the configuration, since the light source device 30A emits the white light LW, with only one light source device, the projector 10 having the highly efficient and simple configuration can be realized.

### Second Embodiment

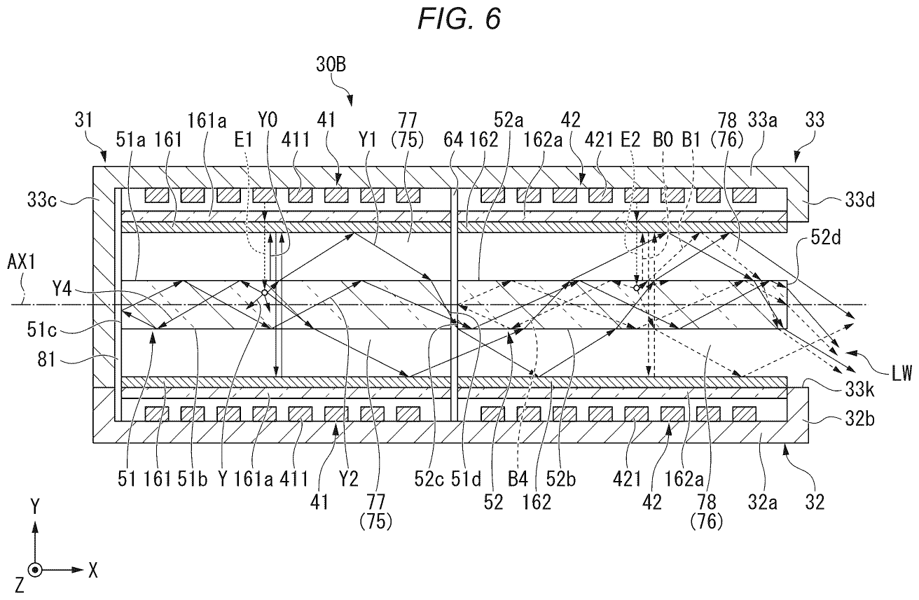

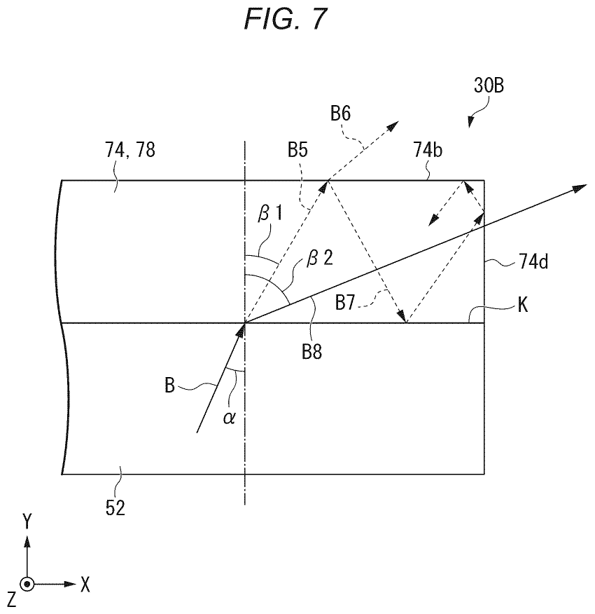

As below, a second embodiment of the present disclosure will be described below using FIGS. 6 and 7.

The basic configuration of the light source device of the second embodiment is the same as that of the first embodiment, but the configurations of the respective light guide portions are different from those of the first embodiment. Accordingly, the description of the basic configuration of the light source device is omitted.

FIG. 6 is a cross-sectional view of a light source device 30B of the second embodiment cut along the XY-plane. In FIG. 6, the component elements common to those in the drawings used in the first embodiment have the same signs and the description thereof is omitted.

As shown in FIG. 6, the light source device 30B of the embodiment includes a housing 31, first light sources 41, a first wavelength conversion element 51, first optical layers 161, first light guide portions 75, second light sources 42, a second wavelength conversion element 52, second optical layers 162, second light guide portions 76, a first reflection member 81, a second reflection member (not shown), a third reflection member (not shown), and a fourth optical layer 64.

In the light source device 30A of the first embodiment, the first light-transmissive member 73 is disposed in the first light guide portion 71, and the second light-transmissive member 74 is disposed in the second light guide portions 72. On the other hand, in the light source device 30B of the embodiment, the first light guide portion 75 includes a first air layer 77, and the second light guide portion 76 includes a second air layer 78. That is, the first optical layer 161 and the first wavelength conversion element 51 are disposed apart from each other, and air is present between the first optical layer 161 and the first wavelength conversion element 51. The second optical layer 162 and the second wavelength conversion element 52 are disposed apart from each other, and air is present between the second optical layer 162 and the second wavelength conversion element 52. Therefore, in the embodiment, the first optical layer 161 is formed on a first light-transmissive member 161a held by the lid 33 or the bottom plate 32, and the second optical layer 162 is formed on the surface of a second light-transmissive member 162a held by the lid 33 or the bottom plate 32.

The other configurations of the light source device 30B are the same as those of the light source device 30A of the first embodiment.

### Effects of Second Embodiment

In the embodiment, the same effects as those of the first embodiment can be obtained. That is, the yellow fluorescence Y propagates through the first light guide portion 75 and the second light guide portion 76 and the blue fluorescence B propagates through the second light guide portion 76, and thereby, the light source device 30B with the smaller loss of the yellow fluorescence Y and the blue fluorescence B and the higher use efficiency of the yellow fluorescence Y and the blue fluorescence B that can efficiently emit the white light LW can be realized.

As below, effects of the fluorescence Y propagating through the first air layer 77 and the second air layer 78 will be described.

FIG. 7 is a schematic diagram showing functions of the light source device 30B of the embodiment. The behavior of the yellow fluorescence Y with respect to the first air layer 77 and the behavior of the blue fluorescent light B with respect to the second air layer 78 are substantially the same and, here, the behavior of the blue fluorescent light B with respect to the second air layer 78 is shown and described.

In the first embodiment, as shown in FIG. 7, when the blue fluorescence B generated in the second wavelength conversion element 52 reaches an interface K between the second wavelength conversion element 52 and the second light-transmissive member 74, if an incidence angle α of the blue fluorescence B with respect to the interface K is smaller than the critical angle, the blue fluorescence B is refracted at a refraction angle B1 without being reflected at the interface K and enters the second light-transmissive member 74. Here, when the material of the second wavelength conversion element 52 is SBCA and the material of the light-transmissive member 74 is quartz, the refractive index of the SBCA is, for example, about 1.5 to 2.0, and the refractive index of quartz is about 1.4, and a difference in refractive index between the second wavelength conversion element 52 and the second light-transmissive member 74 is about 0.1 to 0.6 and the difference in refractive index is smaller.

In this case, the refraction angle B1 is not so large with respect to the incidence angle α, and blue fluorescence B5 entering the second light-transmissive member 74 travels in a nearly perpendicular direction to the interface K, that is, a direction forming a large angle with respect to the X-axis. As a result, the blue fluorescence B5 may leak to the outside from a surface 74b of the second light-transmissive member 74 opposite to the interface K and result in a leakage light B6. Or, if the blue fluorescence B5 becomes fluorescence B7 reflected by the surface 74b of the second light-transmissive member 74, when the fluorescence propagates through the second light-transmissive member 74 in the X-axis direction and reaches an end surface 74d of the second light-transmissive member 74, the incidence angle of the blue fluorescence B7 with respect to the end surface 74d is larger, and thus, the blue fluorescence B7 may be reflected by the end surface 74d and not be emitted from the end surface 74d and the extraction efficiency of the blue fluorescence B may be lower.

On the other hand, when the second air layer 78 is adjacent to the second wavelength conversion element 52 as in the embodiment, the refractive index of the SBCA is, for example, about 1.5 to 2.0 and the refractive index of air is 1.0, and a difference in refractive index between the second wavelength conversion element 52 and the second air layer 78 is about 0.5 to 1.0 and the difference in refractive index is larger than that in the first embodiment. Accordingly, a refraction angle B2 is larger than the refraction angle B1, and blue fluorescence B8 entering the second air layer 78 travels in a direction forming a smaller angle with respect to the interface K, that is, a direction forming a smaller angle with respect to the X-axis, as compared with a case where the fluorescence enters the second light-transmissive member 74. As a result, when the blue fluorescence B8 reaches an interface between the second air layer 78 and another substance, it is easier for the fluorescence to be totally reflected and harder to leak to the outside. Further, in the embodiment, since the second air layer 78 is opened to the external space in the extraction opening 33k and has no refractive index interface, the blue fluorescence B8 reaching the extraction opening 33k is not reflected or refracted, but emitted to the external space without change. With respect to the yellow fluorescence Y, the same effects as those of the blue fluorescence B can be obtained. With the above described functions, according to the light source device 30B of the embodiment, the extraction efficiency of the yellow fluorescence Y and the blue fluorescence B can be increased as compared with the first embodiment.

According to the configuration of the embodiment, since adhesives used in the first embodiment for bonding the respective wavelength conversion elements 51, 52 and the respective light-transmissive members 73, 74 is not necessary, there is no deterioration due to the temporal change of the adhesives, and the life of the light source device 30B can be extended. In addition, since the step of joining the respective wavelength conversion elements 51, 52 and the respective light-transmissive members 73, 74 is not necessary, the manufacturing process can be simplified as compared with the first embodiment.

### Third Embodiment

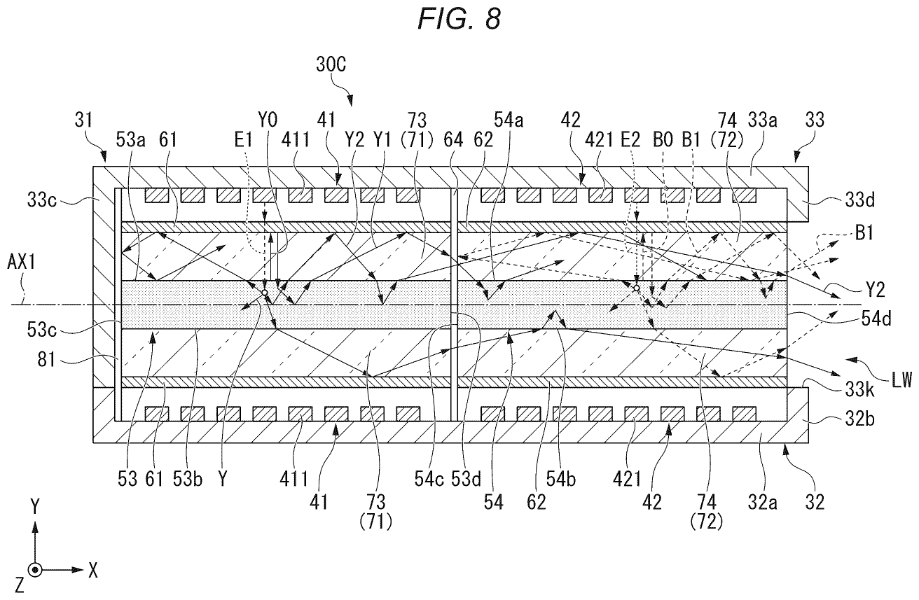

As below, a third embodiment of the present disclosure will be described below using FIG. 8.

The basic configuration of the light source device of the third embodiment is the same as that of the first embodiment, but the configurations of the respective wavelength conversion elements are different from those of the first embodiment. Accordingly, the description of the basic configuration of the light source device is omitted.

FIG. 8 is a cross-sectional view of a light source device 30C of the third embodiment cut along the XY-plane. In FIG. 8, the component elements common to those in the drawings used in the first embodiment have the same signs and the description thereof is omitted.

As shown in FIG. 8, the light source device 30C of the embodiment includes a housing 31, first light sources 41, a first wavelength conversion element 53, first optical layers 61, first light guide portions 71, second light sources 42, a second wavelength conversion element 54, second optical layers 62, second light guide portions 72, a first reflection member 81, a second reflection member (not shown), a third reflection member (not shown), and a fourth optical layer 64.

In the light source device 30A of the first embodiment, the first wavelength conversion element 51 and the second wavelength conversion element 52 are formed using transparent phosphor. On the other hand, in the light source device 30C of the embodiment, the first wavelength conversion element 53 and the second wavelength conversion element 54 are formed using phosphor having a light scattering property. The phosphor having the light scattering property can be realized by dispersion of a medium having a different refractive index from the transparent phosphor, for example, a scatterer such as pores or fillers in the transparent phosphor. The first wavelength conversion element 53 has a front surface 53a, a back surface 53b, a first end surface 53c, and a second end surface 53d. The second wavelength conversion element 54 has a front surface 54a, a back surface 54b, a first end surface 54c, and a second end surface 54d.

The other configurations of the light source device 30C are the same as those of the light source device 30A of the first embodiment.

### Effects of Third Embodiment

In the embodiment, the same effects as those of the first embodiment can be obtained. That is, the yellow fluorescence Y propagates through the first light guide portion 71 and the second light guide portion 72 and the blue fluorescence B propagates through the second light guide portion 72, and thereby, the light source device 30C with the smaller loss of the yellow fluorescence Y and the blue fluorescence B and the higher use efficiency of the yellow fluorescence Y and the blue fluorescence B that can efficiently emit the white light LW can be realized.

Furthermore, in the embodiment, since the first wavelength conversion element 53 and the second wavelength conversion element 54 are formed using the phosphor having the light scattering property, the following effects can be obtained.

In the first embodiment, since the respective wavelength conversion elements 51 and 52 are formed using the transparent phosphor, scattering does not occur when the respective fluorescence Y and B propagates inside the respective wavelength conversion elements 51 and 52, and the traveling directions of the respective fluorescence Y and B are not changed. Therefore, the respective fluorescence Y and B entering at incidence angles smaller than the critical angle with respect to the front surface 51a and the back surface 51b of the first wavelength conversion element 51 and the front surface 52a and the back surface 52b of the second wavelength conversion element 52 is repeatedly totally reflected at the same incidence angle. As described above, the respective fluorescence Y, B is confined and propagates inside the first wavelength conversion element 51 and the second wavelength conversion element 52, and emitted from the second end surface 52d of the second wavelength conversion element 52.

On the other hand, in the embodiment, since the first wavelength conversion element 53 is formed using the phosphor having the light scattering property, when the yellow fluorescence Y propagates inside the first wavelength conversion element 53, a lot of scattering occurs and the traveling direction of the yellow fluorescence Y is changed at each time of scattering. Therefore, as shown in FIG. 8, for example, the yellow fluorescence Y1 reflected by the first optical layer 61 and entering the first wavelength conversion element 53 is scattered by the first wavelength conversion element 53 and changed in angle and enters the first light-transmissive member 73, is reflected by the first optical layer 61, and is emitted from the region of the first light-transmissive member 73 at the second end surface 53d side. Further, part of the fluorescence Y2 is sequentially transmitted through the first light-transmissive member 73, the fourth optical layer 64, and the second light-transmissive member 74, and enters the second wavelength conversion element 54. The yellow fluorescence Y2 entering the second wavelength conversion element 54 is scattered by the second wavelength conversion element 54 and changed in angle and enters the second light-transmissive member 74, and is emitted from the region of the second light-transmissive member 74 at the second end surface 54d side.

The blue fluorescence B exhibits the same behavior as the yellow fluorescence Y. For example, the blue fluorescence B1 reflected by the second optical layer 62 and entering the second wavelength conversion element 54 is scattered by the second wavelength conversion element 54 and changed in angle and enters the second light-transmissive member 74, and is emitted from the region of the second light-transmissive member 74 at the second end surface 54d side. As described above, in the embodiment, the yellow fluorescence Y and the blue fluorescence B confined and propagating inside the first wavelength conversion element 51 and the second wavelength conversion element 52 is almost absent.

In the first embodiment, the first wavelength conversion element 51 is formed using the transparent phosphor, and the traveling direction of the yellow fluorescence Y is not changed inside the first wavelength conversion element 51. Accordingly, of the yellow fluorescence Y emitted from the first wavelength conversion element 51, as shown in FIG. 3, yellow fluorescence Y0 perpendicularly entering the first optical layer 61 is repeatedly reflected between the two first optical layers 61. On the other hand, in the embodiment, the yellow fluorescence Y0 perpendicularly entering the first optical layer 61 is reflected by the first optical layer 61, then, scattered by the first wavelength conversion element 53 when entering the first wavelength conversion element 53 and changed in angle. Accordingly, the fluorescence is not repeatedly reflected between the two first optical layers 61, but propagates inside the first light-transmissive member 73 and the second light-transmissive member 74, and then, is emitted to the outside. Similarly, blue fluorescence BC perpendicularly entering the second optical layer 62 is scattered by the second wavelength conversion element 54 when entering the second wavelength conversion element 54 and changed in angle. Accordingly, the fluorescence is not repeatedly reflected between the two second optical layers 62, but propagates inside the second light-transmissive member 74, and then, is emitted to the outside.

As described above, in the embodiment, the respective fluorescence Y and B is not confined inside the first wavelength conversion element 53 and the second wavelength conversion element 54, but emitted to the first light-transmissive member 73 and the second light-transmissive member 74, propagates inside the first light-transmissive member 73 and the second light-transmissive member 74, and then, is emitted from the region of the second light-transmissive member 74 at the second end surface 54d side.

As described above, the yellow fluorescence Y propagates through the first light guide portion 71 while repeating the scattering by the first wavelength conversion element 53 and the reflection by the first optical layer 61 and is emitted from the region of the first light guide portion 71 at the second end surface 53d side, and the yellow fluorescence Y emitted from the first light guide portion 71 and the blue fluorescence B propagate through the second light guide portion 72 while being repeatedly scattered by the second wavelength conversion element 54 and reflected by the second optical layer 62 and is emitted from the region of the second light guide portion 72 at the second end surface 54d. As a result, the loss when the respective fluorescence Y and B propagates through the first wavelength conversion element 53 and the second wavelength conversion element 54 is suppressed, and thus, the use efficiency of the respective fluorescence Y and B can be further increased as compared with the first embodiment.

### Fourth Embodiment

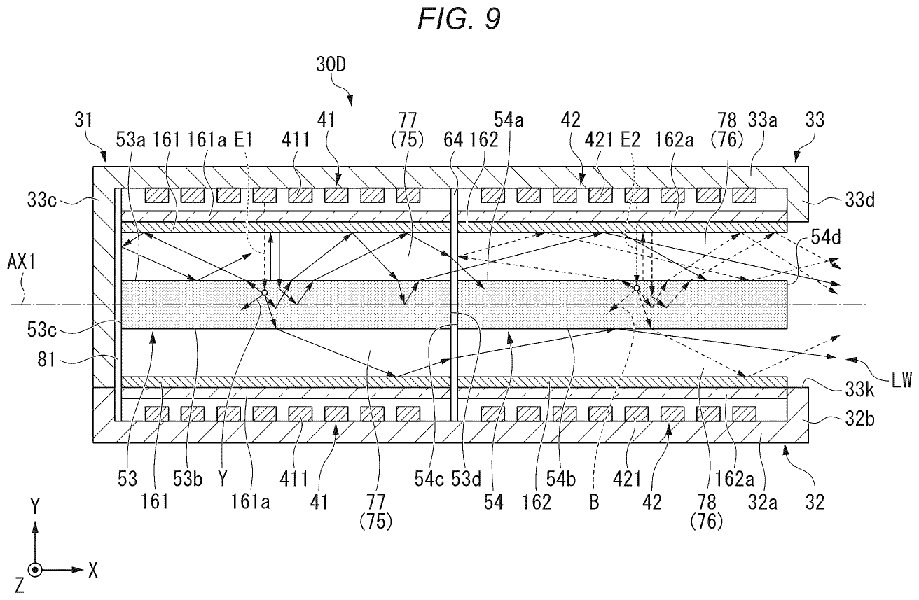

As below, a fourth embodiment of the present disclosure will be described using FIG. 9.

The basic configuration of the light source device of the fourth embodiment is the same as that of the second embodiment, but the configurations of the respective wavelength conversion elements are different from those of the second embodiment. Accordingly, the description of the basic configuration of the light source device is omitted.

FIG. 9 is a cross-sectional view of a light source device 30D of the fourth embodiment cut along the XY-plane. In FIG. 9, the component elements common to those in FIG. 6 used in the second embodiment have the same signs and the description thereof is omitted.

As shown in FIG. 9, the light source device 30D of the embodiment includes a housing 31, first light sources 41, a first wavelength conversion element 53, first optical layers 161, first light guide portions 75, second light sources 42, a second wavelength conversion element 54, second optical layers 162, second light guide portions 76, a first reflection member 81, a second reflection member (not shown), a third reflection member (not shown), and a fourth optical layer 64.

In the light source device 30B of the second embodiment, the first wavelength conversion element 51 and the second wavelength conversion element 52 are formed using transparent phosphor. On the other hand, in the light source device 30D of the embodiment, the first wavelength conversion element 53 and the second wavelength conversion element 54 are formed using phosphor having a light scattering property like the third embodiment. The first wavelength conversion element 53 has a front surface 53a, a back surface 53b, a first end surface 53c, and a second end surface 53d. The second wavelength conversion element 54 has a front surface 54a, a back surface 54b, a first end surface 54c, and a second end surface 54d.

The other configurations of the light source device 30D are the same as those of the light source device 30B of the second embodiment.

### Effects of Fourth Embodiment

In the embodiment, the same effects as those of the first embodiment can be obtained. That is, the yellow fluorescence Y propagates through the first light guide portion 75 and the second light guide portion 76 and the blue fluorescence B propagates through the second light guide portion 76, and thereby, the light source device 30D with the smaller loss of the yellow fluorescence Y and the blue fluorescence B and the higher use efficiency of the yellow fluorescence Y and the blue fluorescence B that can efficiently emit the white light LW can be realized.

Further, in the embodiment, the same effect as that of the second embodiment can be obtained. That is, the first light guide portion 75 includes the first air layer 77 and the second light guide portion 76 includes the second air layer 78, and thereby, the extraction efficiency of the yellow fluorescence Y and the blue fluorescence B can be increased as compared with the first embodiment. In addition, the same effects as those of the third embodiment can be obtained. That is, the first wavelength conversion element 53 and the second wavelength conversion element 54 are formed using the phosphor having the light scattering property, and thereby, the loss when the respective fluorescence Y and B propagates through the first wavelength conversion element 53 and the second wavelength conversion element 54 can be suppressed, and the use efficiency of the respective fluorescence Y and B can be increased as compared with the first embodiment.

### Fifth Embodiment

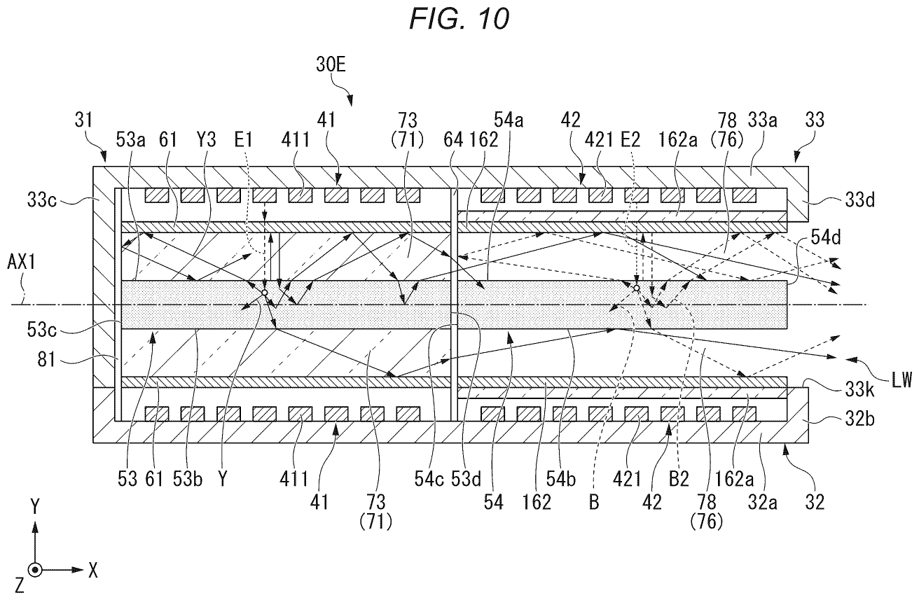

As below, a fifth embodiment of the present disclosure will be described using FIG. 10.

The basic configuration of the light source device of the fifth embodiment is the same as that of the third embodiment, but the configurations of the respective light guide portions are different from those of the third embodiment. Accordingly, the description of the basic configuration of the light source device is omitted.

FIG. 10 is a cross-sectional view of a light source device 30E of the fifth embodiment cut along the XY-plane. In FIG. 10, the component elements common to those in FIG. 8 used in the third embodiment have the same signs and the description thereof is omitted.

As shown in FIG. 10, the light source device 30E of the embodiment includes a housing 31, first light sources 41, a first wavelength conversion element 53, first optical layers 61, first light guide portions 71, second light sources 42, a second wavelength conversion element 54, second optical layers 162, second light guide portions 76, a first reflection member 81, a second reflection member (not shown), a third reflection member (not shown), and a fourth optical layer 64.

In the light source device 30E of the embodiment, the first light guide portion 71 includes a light-transmissive member 73, and the second light guide portion 76 includes an air layer 78. That is, both the first light guide portion and the second light guide portion do not necessarily include light-transmissive members or air layers like the above described embodiments, however, one of the portions may include a light-transmissive member and the other may include an air layer. In this case, as in the embodiment, it is more preferable that the first light guide portion is a light-transmissive member and the second optical layer is an air layer than that the first light guide portion is an air layer and the second optical layer is a light-transmissive member. This is because the configuration in which the second optical layer closer to the extraction opening is an air layer has the greater effect of increasing the extraction efficiency of the respective fluorescence Y and B than the configuration in which the second optical layer closer to the extraction opening is a light-transmissive member.

The other configurations of the light source device 30E are the same as those of the light source device 30C of the third embodiment.

### Effects of Fifth Embodiment

In the embodiment, the same effects as those of the first embodiment can be obtained. That is, the yellow fluorescence Y propagates through the first light guide portion 71 and the second light guide portion 76 and the blue fluorescence B propagates through the second light guide portion 76, and thereby, the light source device 30E with the smaller loss of the yellow fluorescence Y and the blue fluorescence B and the higher use efficiency of the yellow fluorescence Y and the blue fluorescence B that can efficiently emit the white light LW can be realized.

### Sixth Embodiment

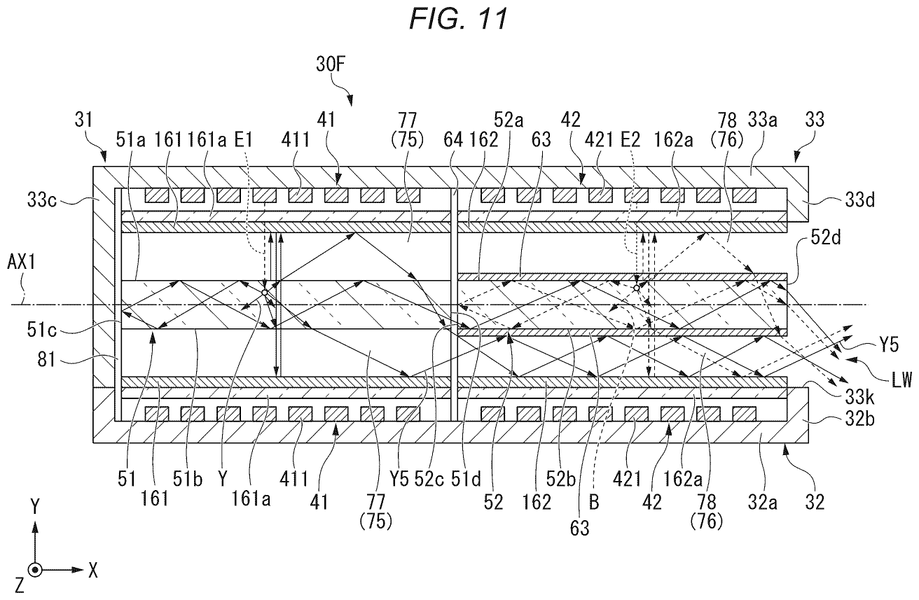

As below, a sixth embodiment of the present disclosure will be described using FIG. 11.

The basic configuration of the light source device of the sixth embodiment is the same as that of the second embodiment, but the sixth embodiment is different from the second embodiment in that a third optical layer is provided. Accordingly, the description of the basic configuration of the light source device is omitted.

FIG. 11 is a cross-sectional view of a light source device 30F of the sixth embodiment cut along the XY-plane. In FIG. 11, the component elements common to those in FIG. 6 used in the second embodiment have the same signs and the description thereof is omitted.

As shown in FIG. 11, the light source device 30F of the embodiment includes a housing 31, first light sources 41, a first wavelength conversion element 51, first optical layers 161, first light guide portions 75, second light sources 42, a second wavelength conversion element 52, second optical layers 162, second light guide portions 76, a first reflection member 81, a second reflection member (not shown), a third reflection member (not shown), a fourth optical layer 64, and third optical layers 63.

The third optical layers 63 are disposed on a front surface 52a and a back surface 52b of the second wavelength conversion element 52. The third optical layer 63 has an optical property of reflecting the yellow fluorescence Y and transmit the second excitation light E2 and the blue fluorescence B. The third optical layers 63 include dielectric multilayer films formed on the front surface 52a and the back surface 52b of the second wavelength conversion element 52.

The other configurations of the light source device 30F are the same as those of the light source device 30B of the second embodiment.

### Effects of Sixth Embodiment

In the embodiment, the same effects as those of the first embodiment can be obtained. That is, the yellow fluorescence Y propagates through the first light guide portion 75 and the second light guide portion 76 and the blue fluorescence B propagates through the second light guide portion 76, and thereby, the light source device 30F with the smaller loss of the yellow fluorescence Y and the blue fluorescence B and the higher use efficiency of the yellow fluorescence Y and the blue fluorescence B that can efficiently emit the white light LW can be realized.

In the above described embodiments without the third optical layers 63, part of the yellow fluorescence Y entering the second light guide portion from the first light guide portion enters the second wavelength conversion element and is absorbed. Thereby, the use efficiency of yellow fluorescence Y may be lower. On the other hand, according to the configuration of the embodiment, as shown in FIG. 11, yellow fluorescence Y5 entering the second light guide portion 76 from the first light guide portion 75 is reflected by the third optical layer 63, and thus, does not enter the second wavelength conversion element 52. Thereby, the use efficiency of yellow fluorescence Y can be increased as compared with the above described embodiments. As a result, the light source device 30F with higher efficiency can be realized.

### Seventh Embodiment

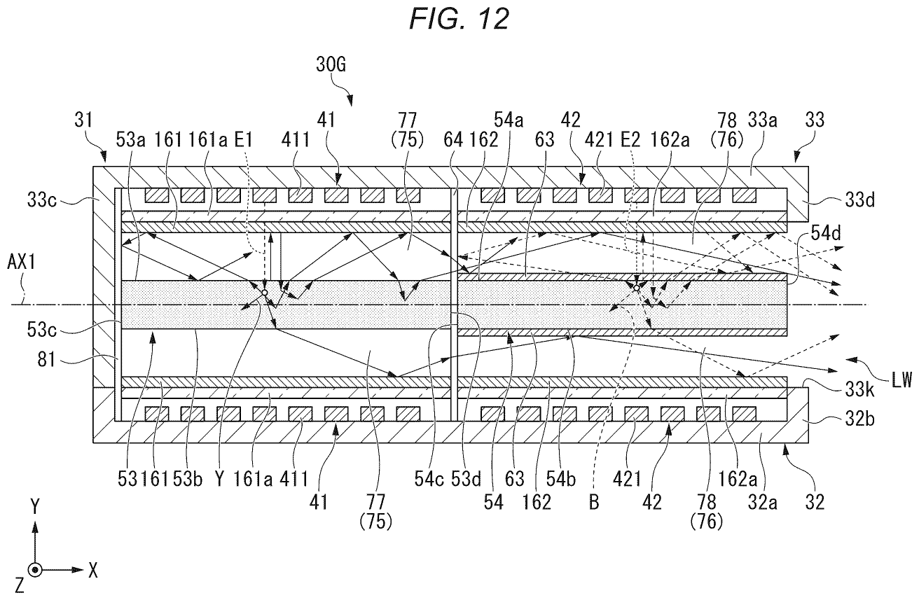

As below, a seventh embodiment of the present disclosure will be described using FIG. 12.

The basic configuration of the light source device of the seventh embodiment is the same as that of the fourth embodiment, but the seventh embodiment is different from the fourth embodiment in that a third optical layer is provided. Accordingly, the description of the basic configuration of the light source device is omitted.

FIG. 12 is a cross-sectional view of a light source device 30G of the seventh embodiment cut along the XY-plane. In FIG. 12, the component elements common to those in FIG. 9 used in the fourth embodiment have the same signs and the description thereof is omitted.

As shown in FIG. 12, the light source device 30G of the embodiment includes a housing 31, first light sources 41, a first wavelength conversion element 53, first optical layers 161, first light guide portions 75, second light sources 42, a second wavelength conversion element 54, second optical layers 162, second light guide portions 76, a first reflection member 81, a second reflection member (not shown), a third reflection member (not shown), a fourth optical layer 64, and third optical layers 63.

Like the sixth embodiment, the third optical layers 63 are disposed on a front surface 54a and a back surface 54b of the second wavelength conversion element 54. The third optical layer 63 has an optical property of reflecting the yellow fluorescence Y and transmit the second excitation light E2 and the blue fluorescence B. The third optical layers 63 include dielectric multilayer films formed on the front surface 54a and the back surface 54b of the second wavelength conversion element 54.

The other configurations of the light source device 30G are the same as those of the light source device 30D of the fourth embodiment.

### Effects of Seventh Embodiment

In the embodiment, the same effects as those of the first embodiment can be obtained. That is, the yellow fluorescence Y propagates through the first light guide portion 75 and the second light guide portion 76 and the blue fluorescence B propagates through the second light guide portion 76, and thereby, the light source device 30G with the smaller loss of the yellow fluorescence Y and the blue fluorescence B and the higher use efficiency of the yellow fluorescence Y and the blue fluorescence B that can efficiently emit the white light LW can be realized.

Further, the same effects as those of the second embodiment can be obtained. That is, the light guide portions 75, 76 include air layers, and thereby, the extraction efficiency of the yellow fluorescence Y and the blue fluorescence B can be increased as compared with the first embodiment. Furthermore, the same effects as those of the third embodiment can be obtained. That is, the respective wavelength conversion elements 53, 54 are formed using the phosphor having the light scattering property, and thereby, the loss when the respective fluorescence Y and B propagates through the wavelength conversion elements 53, 54 can be suppressed, and the use efficiency of the respective fluorescence Y and B can be increased as compared with the first embodiment. In addition, the same effects as those of the sixth embodiment can be obtained. That is, the yellow fluorescence Y entering the second light guide portion 76 from the first light guide portion 75 is reflected by the third optical layer 63, and thereby, the use efficiency of the yellow fluorescence Y can be increased and the small light source device 30G with higher efficiency can be realized.

When the third optical layers 63 are disposed on the front surface 54a and the back surface 54b of the second wavelength conversion element 54 like the sixth embodiment and the seventh embodiment, it is desirable that the second light guide portions 76 include air layers. This is because, when the second light guide portions 76 include air layers, since a difference in refractive index between the second wavelength conversion element 54 and the air layer is larger, designing and manufacturing of the dielectric multilayer films forming the third optical layers 63 are easier. If the second light guide portions 76 include light-transmissive members of quartz or the like, since the difference in refractive index between the second wavelength conversion element 54 and the light-transmissive member is smaller, designing and manufacturing of the dielectric multilayer films forming the third optical layers 63 are extremely harder.

Note that the technical scope of the present disclosure is not limited to the above described embodiments, but various changes can be made without departing from the scope of the present disclosure.

As the constituent material of the first wavelength conversion element, for example, composite phosphor containing AlN and Ce:YAG may be used. According to the configuration, even when the contact area between the first wavelength conversion element and the housing is too small to secure a large number of heat dissipation paths like the second embodiment, the thermal conductivity of the first wavelength conversion element can be increased as compared with a case where phosphor of only Ce:YAG is used. Thereby, the cooling efficiency of the first wavelength conversion element can be increased. Accordingly, the maximum amount of the first excitation light can be increased, and the maximum output of the yellow fluorescence can be increased. Similarly, composite phosphor may be used for the second wavelength conversion element.

In the above described embodiments, the example in which the first light guide portions and the first optical layers are disposed on the front surface and the back surface of the first wavelength conversion element, and the second light guide portions and the second optical layers are disposed on the front surface and the back surface of the second wavelength conversion element is taken. Instead of this configuration, the first light guide portions and the first optical layers may be disposed on one of the front surface and the back surface of the first wavelength conversion element, and the second light guide portions and the second optical layers may be disposed on one of the front surface and the back surface of the second wavelength conversion element. According to the configuration, the others of the front surface and the back surface of the respective wavelength conversion elements can be brought into contact with the housing, and the cooling efficiency of the respective wavelength conversion elements can be increased. Accordingly, the maximum amounts of the respective excitation lights can be increased, and the maximum output of yellow fluorescence and blue fluorescence B can be increased.

Although a problem that part of the blue fluorescence is absorbed by the first wavelength conversion element arises, the light source device of the present disclosure does not necessarily include the fourth optical layer as long as the loss of blue fluorescence can be allowed.

In the above described embodiments, the first wavelength range is, for example, the violet-to-blue wavelength range from 400 nm to 480 nm, and the third wavelength range is, for example, the ultraviolet wavelength range having the center wavelength of 380 nm, however, the wavelength ranges are not limited thereto. The first wavelength range may be, for example, a blue wavelength range from 430 nm to 480 nm, and the third wavelength range may be a violet wavelength range having a center wavelength of, for example, 400 nm.

In addition, the specific description of the shapes, the numbers, the arrangements, the materials, and the like of the respective component elements of the light source device and the projector are not limited to those in the above described embodiments, but changes can be made as appropriate. Further, in the above described embodiments, the example in which the light source device according to the present disclosure is provided in the projector using the liquid crystal panels is shown, however, the application is not limited to that. The light source device according to the present disclosure may be applied to a projector using digital micromirror devices as the light modulation devices. Further, the projector does not necessarily have the plurality of light modulation devices, but may have a single light modulation device.

In the above described embodiments, the example in which the light source device according to the present disclosure is applied to the projector is shown, however, the application is not limited to that. The light source device according to the present disclosure may be applied to a lighting apparatus, a headlight of an automobile, or the like.

### Summary of Present Disclosure

The summary of the present disclosure is appended as below.

### Appendix 1

A light source device includes a first light source emitting a first light in a first wavelength range, a first wavelength conversion element converting the first light into a second light in a second wavelength range different from the first wavelength range, a first optical layer disposed between the first light source and the first wavelength conversion element and transmitting the first light and reflecting the second light, a first light guide portion disposed between the first optical layer and the first wavelength conversion element and guiding the second light converted by the first wavelength conversion element, a second light source emitting a third light in a third wavelength range, a second wavelength conversion element converting the third light into a fourth light in a fourth wavelength range different from the third wavelength range or the second wavelength range, a second optical layer disposed between the second light source and the second wavelength conversion element and transmitting the third light and reflecting the fourth light, a second light guide portion disposed between the second optical layer and the second wavelength conversion element and guiding the fourth light converted by the second wavelength conversion element, and a first reflection member reflecting the first light and the second light, wherein the first wavelength conversion element includes a first surface entered by the first light via the first optical layer and the first light guide portion, and a second surface and a third surface crossing the first surface and facing opposite sides, the second wavelength conversion element includes a fourth surface entered by the third light via the second optical layer and the second light guide portion, and a fifth surface and a sixth surface crossing the fourth surface and facing opposite sides, the first reflection member is disposed in a region at the second surface side of the first light guide portion, the second light converted by the first wavelength conversion element travels through the first light guide portion, is emitted from a region of the first light guide portion at the third surface side, and enters a region of the second light guide portion at the fifth surface side, and the fourth light converted by the second wavelength conversion element and the second light emitted from the region at the third surface side travel through the second light guide portion and are emitted from a region of the second light guide portion at the sixth surface side.

According to the configuration of Appendix 1, the second light is guided by the first light guide portion and the second light guide portion and the fourth light is guided by the second light guide portion, and thereby, the loss of the second light and the fourth light is smaller than that in the light source device of related art. As a result, the light source device with the higher use efficiency of the second light and the fourth light that can efficiently emit a combined light formed by combination of the second light and the fourth light can be realized.

### Appendix 2

In the light source device according to Appendix 1, a first light-transmissive member transmitting the first light and the second light is disposed in the first light guide portion, a second light-transmissive member transmitting the third light and the fourth light is disposed in the second light guide portion, the second light converted by the first wavelength conversion element travels inside the first light-transmissive member and enters the second light-transmissive member, and the fourth light converted by the second wavelength conversion element and the second light emitted from the first light-transmissive member travel inside the second light-transmissive member and are emitted from an end surface of the second light-transmissive member.

According to the configuration of Appendix 2, since the heat of the first wavelength conversion element is transferred to the first light-transmissive member and the heat of the second wavelength conversion element is transferred to the second light-transmissive member, and thereby, a decrease in conversion efficiency due to the temperature rise of the respective wavelength conversion elements can be suppressed.

### Appendix 3

In the light source device according to Appendix 1, the first light guide portion is a first air layer, the second light guide portion is a second air layer, the second light converted by the first wavelength conversion element travels through the first air layer and enters the second air layer, and the fourth light converted by the second wavelength conversion element and the second light emitted from the first air layer travel through the second air layer and are emitted from a region of the second air layer at the sixth surface side.

According to the configuration of Appendix 3, the second light travels in a direction forming a smaller angle with respect to the arrangement direction of the first wavelength conversion element and the second wavelength conversion element, as compared with the configuration of Appendix 2 in which the second light enters the first light-transmissive member. As a result, when the second light reaches interfaces between the respective air layers and substances, it is easier for the light to be totally reflected and harder to leak to the outside. In addition, the fourth light travels in a direction forming a smaller angle with respect to the arrangement direction of the first wavelength conversion element and the second wavelength conversion element, as compared with the configuration of Appendix 2 in which the fourth light enters the second light-transmissive member. As a result, when the second light and the fourth light reach interfaces between the respective air layers and substances, it is easier for the lights to be totally reflected and harder to leak to the outside. Thereby, the extraction efficiency of the second light and the fourth light can be increased.

### Appendix 4

The light source device according to Appendix 3, further includes a third optical layer disposed on the fourth surface of the second wavelength conversion element, and reflecting the second light and transmitting the third light and the fourth light.

According to the configuration of Appendix 4, the third optical layer is disposed on the fourth surface of the second wavelength conversion element, and thereby, entry of the second light into the second wavelength conversion element can be suppressed and absorption of the second light when the second light enters the second wavelength conversion element can be suppressed. Accordingly, the use efficiency of the second light can be increased as compared with the case where the third optical layer is not disposed.

### Appendix 5

In the light source device according to Appendix 1, a light-transmissive member transmitting the first light and the second light is disposed in the first light guide portion, the second light guide portion is an air layer, the second light converted by the first wavelength conversion element travels inside the light-transmissive member and enters the air layer, and the fourth light converted by the second wavelength conversion element and the second light emitted from the light-transmissive member travel through the air layer and are emitted from a region of the air layer at the sixth surface side.

According to the configuration of Appendix 5, the heat of the first wavelength conversion element is transferred to the light-transmissive member, and thereby, a decrease in conversion efficiency due to the temperature rise of the first wavelength conversion element can be suppressed. Further, when the second light and the fourth light reach the interface between the air layer and the other substance, it is easier for the lights to be totally reflected and harder to leak to the outside, and thereby, the extraction efficiency of the second light and the fourth light can be increased.

### Appendix 6

The light source device according to any one of Appendices 1 to 5, further includes a fourth optical layer disposed between the first light guide portion and the second light guide portion, and transmitting the second light and reflecting the third light and the fourth light.

According to the configuration of Appendix 6, since the fourth light traveling inside the second light guide portion toward the first light guide portion side is reflected by the fourth optical layer, the fourth light enters and is absorbed by the first wavelength conversion element, and the loss is suppressed. Accordingly, the use efficiency of the fourth light can be increased.

### Appendix 7

In the light source device according to any one of Appendices 1 to 6, the second wavelength range is larger than the third wavelength range and the fourth wavelength range, and the third wavelength range is smaller than the first wavelength range.

According to the configuration of Appendix 7, the second wavelength range is larger than the third wavelength range and the fourth wavelength range, and thereby, when the second light enters the second wavelength conversion element, entry into and absorption by the second wavelength conversion element can be suppressed. Accordingly, the use efficiency of the second light can be increased.

### Appendix 8

In the light source device according to Appendix 7, the first light is a blue light, the second light is yellow fluorescence, the third light is an ultraviolet light, and the fourth light is blue fluorescence.

According to the configuration of Appendix 8, the light source device that can efficiently emit the white light can be realized.

### Appendix 9

In the light source device according to any one of Appendices 1 to 8, a length of the first wavelength conversion element along an arrangement direction in which the first wavelength conversion element and the second wavelength conversion element are arranged is larger than a length of the second wavelength conversion element along the arrangement direction.

According to the configuration of Appendix 9, the amount of the second light, which is likely to result in a larger loss due to a longer path to pass through, can be made larger than the amount of the fourth light. Thereby, the combined light having a desired color temperature can be easily obtained.

### Appendix 10

The light source device according to any one of Appendices 1 to 9, further includes second reflection members reflecting the first light and the second light, and third reflection members reflecting the third light and the fourth light, wherein the first wavelength conversion element includes a seventh surface and an eighth surface crossing the first surface, the second surface, and the third surface and facing opposite sides to each other, the second wavelength conversion element includes a ninth surface and a tenth surface crossing the fourth surface, the fifth surface, and the sixth surface and facing opposite sides to each other, the second reflection members are disposed in a region at the seventh surface side of the first light guide portion and a region at the eighth surface side of the first light guide portion, and the third reflection members are disposed in a region at the ninth surface side of the second light guide portion and a region at the tenth surface side of the second light guide portion.

According to the configuration of Appendix 10, the conversion efficiency from the first light into the second light can be increased by the second reflection members, and the loss of the second light can be suppressed. In addition, the conversion efficiency from the third light to the fourth light can be increased by the third reflection members, and the loss of the fourth light can be suppressed.

### Appendix 11

The light source device according to any one of Appendices 1 to 10, further includes a housing covering the first optical layer, the second optical layer, the first wavelength conversion element, and the second wavelength conversion element, wherein the housing has an extraction opening for extraction of the second light and the fourth light emitted from the region of the second light guide portion at the sixth surface side to the outside, and, in a plan view in a normal direction of the sixth surface of the second wavelength conversion element, the extraction opening overlaps with the second light guide portion and the second wavelength conversion element.

According to the configuration of Appendix 11, the first optical layer, the second optical layer, the first wavelength conversion element, and the second wavelength conversion element can be protected by the housing, and the second light and the fourth light propagating through the first light guide portion and the second wavelength conversion element can be extracted to the outside through the extraction opening of the housing.

### Appendix 12

In the light source device according to any one of Appendices 1 to 11, the first wavelength conversion element and the second wavelength conversion element are formed using transparent phosphor.

According to the configuration of Appendix 12, even when the first wavelength conversion element and the second wavelength conversion element formed using the transparent phosphor are used, the amount of the incident first light and third light is increased without upsizing of the respective wavelength conversion elements, and thereby, the second light and the fourth light can be efficiently extracted to the outside with the increased conversion efficiency of the second light and the fourth light.

### Appendix 13

In the light source device according to any one of Appendices 1 to 11, the first wavelength conversion element and the second wavelength conversion element are formed using phosphor having a light scattering property.

According to the configuration of Appendix 13, the second light generated inside the first wavelength conversion element is efficiently emitted to the first light guide portion and propagates through the first light guide portion and the second light guide portion, and thereby, the loss of the second light can be suppressed and the extraction efficiency of the second light can be further increased. Further, the fourth light generated inside the second wavelength conversion element is efficiently emitted to the second light guide portion and propagates through the second light guide portion, and thereby, the extraction efficiency of the fourth light can be further increased.

### Appendix 14

In the light source device according to Appendix 13, the first wavelength conversion element contains yellow phosphor, the first light is a blue light, the second light is yellow fluorescence, the second wavelength conversion element contains blue phosphor, the third light is an ultraviolet light, the fourth light is blue fluorescence, the yellow fluorescence propagates through the first light guide portion while being repeatedly scattered by the first wavelength conversion element and reflected by the first optical layer and is emitted from a region of the first light guide portion at the third surface side, and the yellow fluorescence emitted from the first light guide portion and the blue fluorescence propagate through the second light guide portion while being repeatedly scattered by the second wavelength conversion element and reflected by the second optical layer, and are emitted from a region of the second light guide portion at the sixth surface side.

According to the configuration of Appendix 14, the yellow fluorescence generated inside the first wavelength conversion element and the blue fluorescence generated inside the second wavelength conversion element can be efficiently extracted to the outside from the region of the first light guide portion at the sixth surface side.

### Appendix 15

A projector includes the light source device according to any one of Appendix 1 to Appendix 14, a light modulation device modulating a light emitted from the light source device, and a projection optical device projecting the light modulated by the light modulation device.

According to the configuration of Appendix 15, since the light source device emits the combined light formed by combination of the second light and the fourth light, with only one light source device, the projector having the highly efficient and simple configuration can be realized.

What is claimed is:

1. A light source device comprising:
a first light source emitting a first light in a first wavelength range;
a first wavelength conversion element converting the first light into a second light in a second wavelength range different from the first wavelength range;
a first optical layer disposed between the first light source and the first wavelength conversion element and transmitting the first light and reflecting the second light;
a first light guide portion disposed between the first optical layer and the first wavelength conversion element and guiding the second light converted by the first wavelength conversion element;
a second light source emitting a third light in a third wavelength range;
a second wavelength conversion element converting the third light into a fourth light in a fourth wavelength range different from the third wavelength range or the second wavelength range;
a second optical layer disposed between the second light source and the second wavelength conversion element and transmitting the third light and reflecting the fourth light;
a second light guide portion disposed between the second optical layer and the second wavelength conversion element and guiding the fourth light converted by the second wavelength conversion element; and
a first reflection member reflecting the first light and the second light, wherein
the first wavelength conversion element includes a first surface entered by the first light via the first optical layer and the first light guide portion, and a second surface and a third surface crossing the first surface and facing opposite sides,
the second wavelength conversion element includes a fourth surface entered by the third light via the second optical layer and the second light guide portion, and a fifth surface and a sixth surface crossing the fourth surface and facing opposite sides,
the first reflection member is disposed in a region at the second surface side of the first light guide portion,
the second light converted by the first wavelength conversion element travels through the first light guide portion, is emitted from a region of the first light guide portion at the third surface side, and enters a region of the second light guide portion at the fifth surface side, and
the fourth light converted by the second wavelength conversion element and the second light emitted from the region at the third surface side travel through the second light guide portion and are emitted from a region of the second light guide portion at the sixth surface side.

2. The light source device according to claim 1, wherein
a first light-transmissive member transmitting the first light and the second light is disposed in the first light guide portion,
a second light-transmissive member transmitting the third light and the fourth light is disposed in the second light guide portion,
the second light converted by the first wavelength conversion element travels inside the first light-transmissive member and enters the second light-transmissive member, and
the fourth light converted by the second wavelength conversion element and the second light emitted from the first light-transmissive member travel inside the second light-transmissive member and are emitted from an end surface of the second light-transmissive member.

3. The light source device according to claim 1, wherein
the first light guide portion is a first air layer,
the second light guide portion is a second air layer,
the second light converted by the first wavelength conversion element travels through the first air layer and enters the second air layer, and
the fourth light converted by the second wavelength conversion element and the second light emitted from the first air layer travel through the second air layer and are emitted from a region of the second air layer at the sixth surface side.

4. The light source device according to claim 3, further comprising a third optical layer disposed on the fourth surface of the second wavelength conversion element, and reflecting the second light and transmitting the third light and the fourth light.

5. The light source device according to claim 1, wherein
a light-transmissive member transmitting the first light and the second light is disposed in the first light guide portion,
the second light guide portion is an air layer,
the second light converted by the first wavelength conversion element travels inside the light-transmissive member and enters the air layer, and
the fourth light converted by the second wavelength conversion element and the second light emitted from the light-transmissive member travel through the air layer and are emitted from a region of the air layer at the sixth surface side.

6. The light source device according to claim 1, further comprising a fourth optical layer disposed between the first light guide portion and the second light guide portion, and transmitting the second light and reflecting the third light and the fourth light.

7. The light source device according to claim 1, wherein
the second wavelength range is larger than the third wavelength range and the fourth wavelength range, and
the third wavelength range is smaller than the first wavelength range.

8. The light source device according to claim 7, wherein
the first light is a blue light,
the second light is yellow fluorescence,
the third light is an ultraviolet light, and
the fourth light is blue fluorescence.

9. The light source device according to claim 1, wherein
a length of the first wavelength conversion element along an arrangement direction in which the first wavelength conversion element and the second wavelength conversion element are arranged is larger than a length of the second wavelength conversion element along the arrangement direction.

10. The light source device claim 1, further comprising:
second reflection members reflecting the first light and the second light; and
third reflection members reflecting the third light and the fourth light, wherein
the first wavelength conversion element includes a seventh surface and an eighth surface crossing the first surface, the second surface, and the third surface and facing opposite sides to each other,
the second wavelength conversion element includes a ninth surface and a tenth surface crossing the fourth surface, the fifth surface, and the sixth surface and facing opposite sides to each other,
the second reflection members are disposed in a region at the seventh surface side of the first light guide portion and a region at the eighth surface side of the first light guide portion, and
the third reflection members are disposed in a region at the ninth surface side of the second light guide portion and a region at the tenth surface side of the second light guide portion.

11. The light source device according to claim 1, further comprising a housing covering the first optical layer, the second optical layer, the first wavelength conversion element, and the second wavelength conversion element, wherein
the housing has an extraction opening for extraction of the second light and the fourth light emitted from the region of the second light guide portion at the sixth surface side to the outside, and
in a plan view in a normal direction of the sixth surface of the second wavelength conversion element, the extraction opening overlaps with the second light guide portion and the second wavelength conversion element.

12. The light source device according to claim 1, wherein
the first wavelength conversion element and the second wavelength conversion element are formed using transparent phosphor.

13. The light source device according to claim 1, wherein
the first wavelength conversion element and the second wavelength conversion element are formed using phosphor having a light scattering property.

14. The light source device according to claim 13, wherein
the first wavelength conversion element contains yellow phosphor,
the first light is a blue light,
the second light is yellow fluorescence,
the second wavelength conversion element contains blue phosphor,
the third light is an ultraviolet light,
the fourth light is blue fluorescence,
the yellow fluorescence propagates through the first light guide portion while being repeatedly scattered by the first wavelength conversion element and reflected by the first optical layer and is emitted from a region of the first light guide portion at the third surface side, and
the yellow fluorescence emitted from the first light guide portion and the blue fluorescence propagate through the second light guide portion while being repeatedly scattered by the second wavelength conversion element and reflected by the second optical layer, and are emitted from a region of the second light guide portion at the sixth surface side.

15. A projector comprising:
the light source device according to claim 1;
a light modulation device modulating a light emitted from the light source device; and
a projection optical device projecting the light modulated by the light modulation device.
